(19) United States
(12) Patent Application Publication
(10) Pub. No.: US 2002/0062451 A1
(43) Pub. Date: May 23, 2002

(54) System and method of providing communication security

(76) Inventors: Edward M. Scheidt, McLean, VA (US); C. Jay Wack, Clarksburg, MD (US)

Correspondence Address: Thomas M. Champagne, Rabin & Champagne, P.C., Suite 500, 1101 14th Street, N.W., Washington, DC, 20005, US

(21) Appl. No.: 09/858,326

(22) Filed: May 16, 2001

Related U.S. Application Data
(60) Provisional application No. 60/098,915, filed on Sep. 1, 1998.
(60) Provisional application No. 60/204,385, filed on May 15, 2000.

(51) Int. Cl. H04L 9/00; H04L 9/32; G06F 11/30; G06F 12/14

(52) U.S. Cl. 713/201

(57) ABSTRACT

A process of checking the authorization and authenticity of an application provided by a user includes authenticating an application authentication file against a domain administrator's public membership key. An application executable is then hashed, and the application hash result is compared to an authentication hash contained in the application authentication file. At this point, services are denied to the application if the application hash and the authentication hash do not match. Configuration assignments in the application authentication file are decoded if the application hash and the authentication hash match. The decoded configuration assignments are compared to the user's configuration assignments. Services are provided to the application if the result of the decode is favorable. Services are denied to the application if the result of the decode is not favorable.

### INCORPORATION BY REFERENCE

This document incorporates by this reference, the entire disclosures of the following U.S. patent applications and patents: 08/974,843 filed Nov. 20, 1997; 09/108,312 filed Jul. 1, 1998; 09/0123,672 filed Feb. 13, 1998; and 60/098,915 filed Sep. 1, 1998. This document also incorporates by reference U.S. Provisional Patent Application No. 60/204,385, which was filed on May 15, 2000.

### FIELD OF THE INVENTION

In general, the present invention relates to methods of providing communication security, and to systems for implementing such methods. In particular, the present invention relates to methods of limiting and controlling perception of and access to objects, both stored and in transit.

### BACKGROUND OF THE INVENTION

In the modern world, communications are passed between parties in a variety of different ways utilizing many different communications media. Electronic communication is becoming increasingly popular as an efficient manner of transferring information, and electronic mail in particular is proliferating due to the immediacy of the medium.

Unfortunately, drawbacks accompany the benefits provided by electronic communication, particularly in the area of privacy. Electronic communications may be intercepted by unintended recipients. Wireless transmissions, such as voice communication by cellular telephone, and electronic mail are especially susceptible to such interception.

The problem of electronic communication privacy has been addressed, and solutions to the problem have been put in place. One form of solution uses cryptography to provide privacy for electronic communication. Cryptography involves the encrypting or encoding of a transmitted or stored message, followed by the decryption or decoding of a received or retrieved message. The message usually takes the form of a digital signal, or a digitized analog signal. If the communication is intercepted during transmission or is extracted from storage by an unauthorized entity, the message is worthless to the interloper, who does not possess the means to decrypt the encrypted message.

In a system utilizing cryptography, the encrypting side of the communication incorporates an encoding device or encrypting engine. The encoding device accepts the plaintext (unencrypted) message and a cryptographic key, and encrypts the plaintext message with the key according to an encrypt relation that is predetermined for the plaintext communication and the key. That is, the message is manipulated with the key in a predetermined manner set forth by the text/key relation to produce a ciphertext (encrypted) message.

Likewise, the decrypting side of the communication incorporates a decoding device or decrypting engine. The decoding device accepts the ciphertext message and a cryptographic key, and decrypts the ciphertext message with the key according to a decrypt relation that is predetermined for the ciphertext message and the key. That is, the message is manipulated with the key in a predetermined manner set forth by the text/key relation to produce a new plaintext message that corresponds with the original plaintext message.

The manner in which the key and the relation are applied in the communication process, and the manner in which keys are managed, define a cryptographic scheme. There are many conventional cryptographic schemes in use today. For example, probably the most popular of these is a public-key cryptographic scheme. According to a scheme of this type, the keys used are actually combinations of a public key component that is available to anyone or to a large group of entities, and a private key component that is specific to the is particular communication.

An important consideration in determining whether a particular cryptographic scheme is adequate for the application is the degree of difficulty necessary to defeat the cryptography, that is, the amount of effort required for an unauthorized person to decrypt the encrypted message. There are a number of ways an unauthorized person may go about attempting to defeat the cryptography of a system. Three of the most popular attacks on cryptographic systems are key exhaustion attacks (trial and error), differential cryptanalysis, and algebraic attacks. Choosing more complicated text/key relations and longer keys are two ways to make a cryptographic scheme less vulnerable to attack, but result in a more expensive system that operates at a slower speed. Thus, unless a clever cryptographic scheme is devised to avoid successful attack, tradeoffs must be made when deciding the level of privacy to be provided.

Once a scheme for effecting cryptography is chosen to suit the constraints of the particular application, the text/key relation is usually the determining factor in how successful the cryptography will be in defeating attacks. This in turn affects the confidence that the parties to a communication will have that their communication will remain private. The measuring tool for a successful implementation of cryptography is trust.

Three influences must be satisfied for cryptography to be acceptable: policy, standards, and technology. Recently, all three influences have been evolving to various degrees, but not in an effective way toward a common solution. In the meantime, cryptography has become a commodity discussion for defense and business. An emerging perception is that there is no single solution that meets the complex demands of information flow, control, and protection. Policy must be broadly defined to reach into the future and capture the evolving encryption technology. To formulate coherent implementations, defense and business need to examine the variety of standards that are emerging, and the new encryption technologies that are aligning with developing policy and standards.

Broadly speaking, there are two distinct types of cryptography: symmetric key cryptography and asymmetric key cryptography. Symmetric key (or secret key) cryptography uses the same key for both encryption and decryption. It is computationally easier, and therefore faster, to use symmetric key cryptography than it is to use asymmetric key cryptography. Asymmetric key cryptography uses key pairs, that is, separate respective keys for encryption and decryption. Because one of the keys of the pair cannot easily be derived from the other key, one key can be made public while the other key is held private. For this reason, asymmetric key cryptography is often referred to as public key cryptography, and the overall system or infrastructure utilizing the asymmetric keys is called a public key infrastructure, or PKI.

In a world in which face-to-face communications are not always feasible, a public key system must be designed to distribute the public keys so that holders of public keys feel confident that they know the real identity of the user controlling the associated private key. One element of such a system might be a trusted third party that distributes keys to end-users. If the procedure, whereby the trusted third party binds a user identity to a pair of cryptographic keys, is the issuance of a certificate that includes the public key of the key pair, this trusted third party may be known as a certificate authority. The third party trust model is managed through the PKI and is based on the model of a telephone directory. PKI serves to associate a signature verification key with a name in a directory. Thus, someone verifying a digital signature can look up in a directory the public key used to verify that signature and find the name of the person associated with the key.

A great deal of time and attention has been focused on the issues associated with building a reliable PKI based on this model. The problems associated with implementation of the model include complex issues of cross certification and hierarchies of certification, as well as issues associated with the issuance and revocation of certificates.

The primary shortcomings of the telephone directory model of PKI are not all technical. It is not clear that users in a defense environment should make a decision to execute a transaction because they have found a counter-party's name in a telephone directory. Merely knowing that there is some connection between a person and a public key is not enough to trust the integrity of the link. Trust is measured by the frequency of a user to access the directory; a high level of trust would be associated with session directory access, while a lower level of trust would be associated with a more periodic access. If the certificates are issued and the user is not authenticated to the directory, additional trust must be derived from some other source. The value of a telephone directory is that the value of its function is well understood. A telephone number is usually associated with a particular telephone in a fixed location connected to the network by wires, and that fixed location is usually an address that corresponds to a specific individual. Digital signatures, however, do not have any commonly recognized association with roles in the infrastructure. Binding the user interface and access control through expanding the certificate model will add more complexity to the infrastructure.

For example, the Department of Defense had a system for secure voice communications called the STU2, which was based on a third-party model to establish a voice link. The program was abandoned due to the high cost of establishing the secure voice link. Multiple calls were required to distribute keys to the two parties of the link. The third party acted as the directory service and managed the distribution of keys. The similarity between the concepts of PKI and STU2 lies in that both used a directory and key distribution from a third source to the link.

While asymmetric key cryptography can provide the advantage of establishing a confidential link without prior key exchange, its performance is slow relative to symmetric key cryptography. Thus, one of the beneficial uses of asymmetric key cryptography is in the transfer of secret keys. The key pairs of the asymmetric key can be associated with access credentials, which can take on various roles.

For example, a credential can represent proportional access to information resulting in control over who talks to whom, about what and where. Another strong feature of an asymmetric key is the ability to enforce read and write privileges for access control to information.

The credential can also represent role-based access to information, enforced at the object level, resulting in a broader authentication capability and in temporary access through role assignment. The credential can also provide one-to-many access control to information or data, or object management similar to multiple part forms in which a party only has access to the sub-form that corresponds to that party's individual right-to-know.

If the advantages of asymmetric key are assimilated into a key management design that also includes symmetric key functions, the basis of the combiner portion of cryptography for the key management system of the invention is realized. The combiner functions introduced into a client-based protocol result in a shift of the cryptographic process to the user. The combiner, with its inherent credential attributes, can map to the information flow and control policies.

To complete the key management architecture, the generation and distribution of the essential keys are supported through a tiered architecture that may be scaled to information domains. These domains represent a methodology for managing data for access and dissemination of information. An inherent feature of the present invention is separation of data enforced through cryptography.

The key management architecture of the invention also provides other advantages, such as 100% key recovery. Recovery can be associated with commercial export encryption regulations and with organizational recovery of data from internal user improprieties. The addition of a token element, such as a smart card, can provide additional integrity assurance to the cryptography process.

The Electronic Key Management System (EKMS) currently provides the classified key generation and distribution architecture for the Department of Defense. In a broad sense, EKMS keys are encrypted or unencrypted symmetric keys, that is, benign PKI keys that include certificate elements. The intent is for Defense to move toward an electronic distribution of keys with accountability and control. A major move would be to distribute keys over an open medium such as the Internet. From a cryptographic perspective, the key management system of the present invention can add two dimensions to the distribution process. First, it can be the basis for a configurable identification procedure providing additional assurances. Second, the key management system of the present invention binds more closely the user to the cryptographic process while incorporating access control.

Costs and support to multiple key management systems must also be examined. Determining the cost of a key management system can be difficult, due to the many variables that must be considered. From one perspective, the cost of cryptography support can be diminished as electronic distribution of keys is realized. The cost associated with PKI is in the server support, in the directory access, and in the necessary communication bandwidth to maintain the dynamics of the information flow. The cost associated with the key management system of the present invention is in the client support provided through the tiered architecture. The key management system of the present invention requires less bandwidth for client support, because once the access control and complementary keying elements are distributed, the user does not need to further access the support mechanism. Key recovery capability is essential to maintain the highest system integrity.

### SUMMARY OF THE INVENTION

A process of checking the authorization and authenticity of an application provided by a user includes authenticating an application authentication file against a domain administrator's public membership key. An application executable is then hashed, and the application hash result is compared to an authentication hash contained in the application authentication file. At this point, services are denied to the application if the application hash and the authentication hash do not match. Configuration assignments in the application authentication file are decoded if the application hash and the authentication hash match. The decoded configuration assignments are compared to the user's configuration assignments. Services are provided to the application if the result of the decode is favorable. Services are denied to the application if the result of the decode is not favorable.

### BRIEF DESCRIPTION OF THE DRAWINGS

FIG. 1 illustrates a key management overview.

FIG. 2 illustrates system security using the system of the invention implemented with the use of a smart token.

FIG. 3 illustrates Diffie-Hellman random value encryption and decryption according to the invention.

FIG. 4 illustrates the combiner function.

FIG. 5 illustrates the combiner function utilizing triple DES.

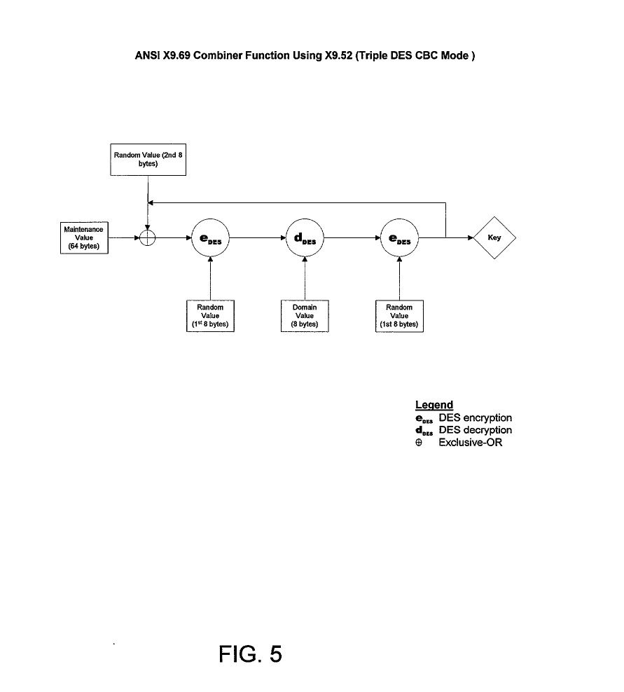

FIG. 6 illustrates the Diffie-Hellman method of encrypting a random value according to the invention.

FIG. 7 illustrates the Diffie-Hellman method of decrypting a random value according to the invention.

FIG. 8 illustrates the RSA method of encrypting the random value according to the invention.

FIG. 9 illustrates the RSA method of decrypting the random value according to the invention.

FIG. 10 illustrates maintenance value and header encrypting key generation.

FIG. 11 illustrates encryption of plaintext data according to the invention.

FIG. 12 illustrates encryption with a digital signature according to the invention.

FIG. 13 illustrates decryption according to the invention.

FIG. 14 illustrates decryption with digital signature verification according to the invention.

FIG. 15 illustrates an exemplary multiple enterprise distribution scenario.

FIG. 16 illustrates enrollment and distribution according to the invention.

FIG. 17 illustrates card enrollment using the Java card of the invention.

FIG. 18 illustrates Java card delivery with organizational second owner.

FIG. 19 illustrates Java card delivery with individual second owner.

FIG. 20 illustrates enrollment in a cardless configuration according to the invention.

FIG. 21 illustrates profile distribution invention according to the invention.

FIG. 22 illustrates workgroup re-assignment according to the invention.

FIG. 23 illustrates an exemplary scenario implementing the system of the invention.

FIG. 24 illustrates application of the scenario of FIG. 23 to the key management overview of FIG. 1.

FIG. 25 illustrates an exemplary multi-dimensional policy representation.

FIG. 26 illustrates policy interpretation engines for different policy languages.

FIG. 27 illustrates a smart token implementation to providing communications security.

FIG. 28 illustrates the administrative hierarchy of the invention.

### DETAILED DESCRIPTION OF THE INVENTION

Working Keys, Combiner Function and Access Control

The system of the invention (which may be referred to herein as “Constructive Key Management”, or “CKM”) uses symmetric key cryptographic algorithms for information encryption. Protection of keys for symmetric key cryptography is paramount if security is to be realized. Combining split key technology with asymmetric key methods gives the invention an effective method of cryptographic key management with access control. This section gives a detailed description of the methods used by the invention to construct keys and provide access control.

The key used in the encryption of an object is called the working key. The working key may be used to supply keying material for a session key or message encrypting key, for example. It is generally large enough (nominally, 512 bits) to supply keys and initialization vectors (IV) for a large variety of symmetric key algorithms. The working key, constructed from several pieces of information (called values), is used to initialize a symmetric key cryptographic algorithm, and is then discarded. The same pieces of information used in constructing the working key for encryption are used to reconstruct the working key for decryption. The function that combines the values to create a working key is at the heart of the invention. It is called the combiner function.

Access control is provided in the invention by applying credentials in the encryption of information. Credentials are selectively distributed to members within a domain. The domain authority effectively grants or denies access to encrypted information. Either symmetric keys or asymmetric key pairs are associated with each credential. Read/write separation (maintaining read and write-access separately from each other) is enforced with asymmetric key cryptography. Read access is equivalent to decryption rights and write access is equivalent to encryption rights.

Administration Concepts

The highest unit of organization in a system is the domain. A domain is a unique, independent entity that includes all the resources needed to function on its own. Policies, procedures and roles are all determined at the domain level. Domains are fully scalable to a wide variety of needs. A domain may be as large as an entire enterprise or as small as a single member.

The domain authority (DA) provides top-level management to a domain. A domain profile refers to all credentials, policy settings, and algorithm permissions established by the domain authority and available within the domain. The domain profile also includes the domain's name and value, the maintenance value, and other information identifying the domain.

A domain consists of at least one and usually several workgroups. A workgroup is a mid-level organization that clusters members (or smaller workgroups) based on common needs and rights to information. Workgroups are often established to parallel departments, locations, projects or other natural organizational subdivisions.

Workgroups are typically managed by a workgroup administrator (WA). The responsibilities performed at this level may be by a person interacting with software, or may be automated in part or in full. The workgroup profile contains all credentials and algorithms available for distribution to the members of a specific workgroup. It also includes the policies governing the workgroup's use of the system of the invention. Workgroup profiles may differ from other profiles in the same domain—defining the unique rights and needs of each group. Workgroup profiles are normally created by the DA.

A member profile includes the credentials, algorithm permissions, and enforced policy settings assigned to an individual by a WA. The member profile also includes the individual's private membership key used to decrypt profile and other membership information sent to the individual. The member profile includes the membership keys of the DA and WA to which the member is assigned. It may typically include one or more global private keys and digital certificates used for encryption or signing in other cryptography systems.

Access Control and I&A

Access control is provided in the system of the invention by applying credentials in the encryption of information. Either symmetric or asymmetric values are associated with each credential. Read/write separation is enforced with asymmetric key encryption. Read access is equivalent to decryption rights and write access is equivalent to encryption rights. Credentials are selectively distributed to members within a domain. In general, an encryption process uses a secure channel to distribute a small amount of information (typically keys) so that a large amount of information (or message) can be distributed securely over unsecured channels. Within the distribution architecture, a domain authority effectively grants or denies access to the encrypted information. A successive level of distribution to the member is included in the architecture.

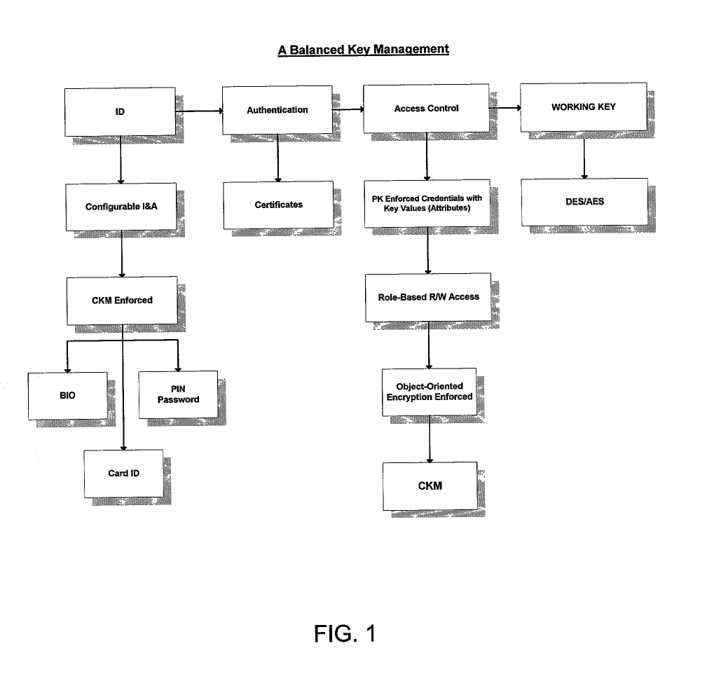

In addition to access control, a broader key management strategy may include a configurable identification capability and a third-party trust authentication capability, as illustrated in FIG. 1.

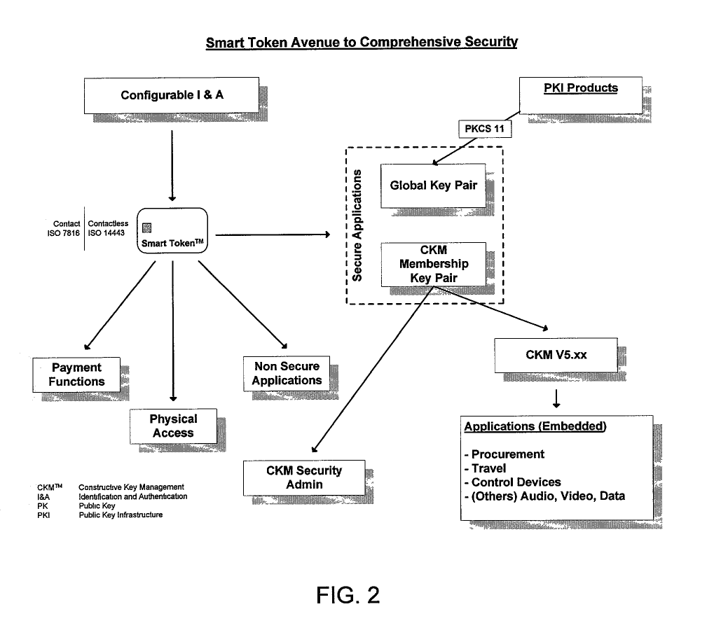

Credentials may be associated with an application that defines one or more member identity elements such as a biometric function, or a smart token identity, or a PIN/password. The system of the invention is used to bind the identity elements to an encrypted object through an encryption process. The object may consist of private keying functions that can authenticate the member to the network and other members. The object may also consist of other functions that may be needed to be stored secretly and that are included in a member profile. Once the identity of a member has been established, the member may need to authenticate that identity through a third party trust model referred to as PKI (Public Key Infrastructure). The essential part of PKI is a certificate that includes a verifiable digital signature, which in itself may be a mathematical hash of information that then is encrypted through an asymmetric process. The PKI authentication support is managed through a smart token. FIG. 2 illustrates a smart token that receives input from a configurable identification and authentication (I&A) process, from managing two types of asymmetric key pairs identified as Global and Membership, from accessing non-secure applications, from providing an option payment function, and from data that acts on a physical access function. The smart token is used as a bridge to multiple authentication and encryption platforms with varying degrees of encryption enforcement and binding.

Write-Only and Read/Write Access

A member's profile contains the domain and maintenance values, but the random value, since it is a one-time value, is distributed or contained with the encrypted object with which it was used. The random value may be protected with symmetric or asymmetric key cryptography. The keys used for random value encryption are the keys associated with credentials chosen by the encrypting member.

The use of triple DES to encrypt the random value is described herein as an exemplary encryption algorithm, for convenience of explanation. It is contemplated that any other symmetric key algorithm can be used with the system and process of the invention. The keys for DES are built by hashing the information from the credentials with the SHA1 (see FIPS standard 180-1) algorithm (or some other hash algorithm), and adjusting the parity bits as required. This will supply 20 bytes (160 bits) for keying material. If more bits are needed, the block of information from the credentials is split in half (or three or whatever number is required), and each piece is hashed, supplying 40 bytes of keying material (20 bytes from each half).

If symmetric key cryptography is used for random value encryption, the keys associated with each applied credential are concatenated, in order, and then hashed.

If asymmetric key technology is used, then the system of the invention has the ability to cryptographically enforce read/write separation of credentials. A Diffie-Hellman private/public (or other static) key pair is associated with each credential. An ephemeral key pair, using the same parameters as the credential key pairs, is generated. The private ephemeral key is combined with each public key using the Diffie-Hellman exponentiation function to derive a number for each credential. These derived numbers are concatenated and hashed to generate the keying material used to encrypt the random value. Along with the encrypted random value, the ephemeral public key will be sent or contained with the encrypted information. The domain-wide Diffie-Hellman parameters are usually stored with a member's profiles.

For decryption, the random value must be recovered from the encrypted random value. The private key portion from each credential used in the encryption process is combined with the ephemeral public key to reconstruct the Diffie-Hellman derived keys. The derived keys are concatenated and hashed. The resulting number is used as the decryption key to recover the random value from the encrypted random value.

Members that are granted write-only (that is, encryption) access to a credential will receive a copy of the public key associated with this credential. Those that are granted read access (for decryption) are given a copy of the private key. In general, a public key may be derivable from a corresponding private key. So knowledge of the decryption key gives a member encrypt access as well. In practice, however, a member with read access will have a copy of both the public and private keys.

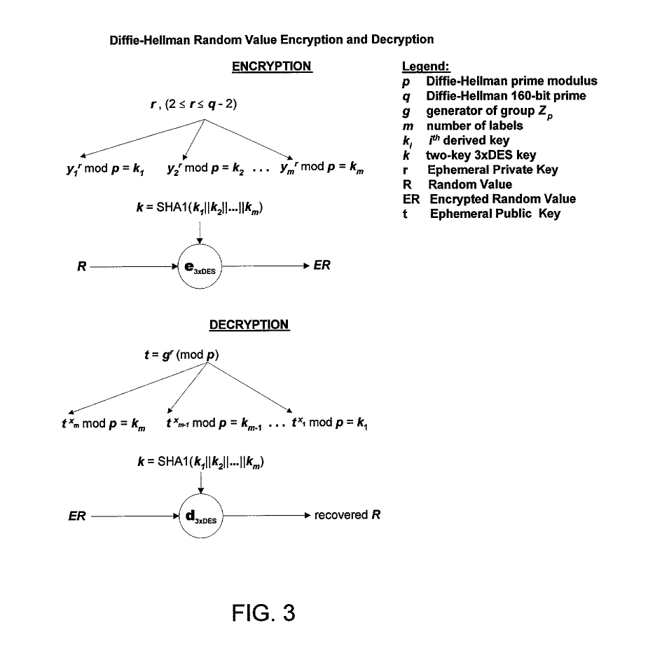

The order in which the random value is encrypted is important. This is handled implicitly by the system of the invention. Each credential has a unique index number associated with it. When encrypting the random value, the public key associated with the credential that has the lowest index number is used as the first encryption key. The public key associated with the credential that has the next lowest index number is used second and so on. See FIG. 3.

The RSA (or another) asymmetric key algorithm may be used in place of Diffie-Hellman. In this case, no hash or symmetric key algorithm is used. The random value is encrypted with each credential's public key, in order. Decryption of the encrypted random value is accomplished by applying the private keys in reverse order.

Multiple encryption of RSA has not been studied as much as multiple symmetric key encryption. Furthermore, a random ephemeral component of the Diffie-Hellman method provides a non-static, one-time key vs. the static keys used with RSA. Thus, the Diffie-Hellman algorithm is preferable to RSA for random value encryption, although RSA and other asymmetric key algorithms are contemplated for use with the system of the invention.

The Combiner Function

Generally, a communication has an origination space and a destination space. The origination space defines the place and time at which the communication originates. The destination space defines the place and time at which the communication is intended to be decoded. The origination space and the destination space may be remote in location. Alternatively, they may be collocated but displaced in time. The space and time correspondence between the origination space and the destination space depends on the nature of a particular communication. The origination space and destination space are coupled to a common communications channel. This communications channel 6 may bridge a physical space, such as empty air in the case of a cellular voice telephone call. Alternatively, the communications channel may be temporary storage for the communication while time passes between the origination space and the destination space, such as a message left in memory on a computer by a first user, for a second user to read at a later time on the same computer. The communications channel 6 may also be a combination of the two, such as telephone cables and storage memory in the case of an electronic mail transmission.

At the origination space, the original plaintext message is received and encrypted according to the encrypt text/key relation, using a provided encrypt key, to create a ciphertext message. The ciphertext message is received at the destination space via the communications channel. An authorized entity having a proper decrypt key can then provide the decrypt key to the destination space, where it is applied to the ciphertext message according to a decrypt text/key relation to create a new plaintext message that corresponds to the original plaintext message.

The origination space and the destination space can be, for example, computers, or even the same computer. An exemplary computer may have a certain amount of storage space in the form of memory for storing the text/key relation. A microprocessor or similar controller, along with a control structure and random access memory for storing original plaintext and keys provided by a user, can be included in each space and can perform the functions of the encryption/decryption engine. An input device such as a keyboard, floppy disk drive, CD-ROM drive, or biometrics reader, can also be provided for accepting the key and plaintext message from the origination user, and the key from the destination user. At the destination space, an output device, such as a monitor, disk drive, or audio speaker, may also be provided to present the new plaintext message to the destination user. The text/key relation can be stored on a floppy disk or other permanent or temporary portable storage, rather than in hard storage in the computer, to allow different text/key relations to be applied by different users or in different situations.

The keys that are provided at the origination space and at the destination space may be composed of several components, or splits, each of which may be provided by a different source. A random key split may be randomly or pseudorandomly generated. A second split may be stored on a token. A third split may be stored on a console, and a fourth split may be provided by a biometric source. The key splits may be combined to form a complete cryptographic key. This key may take the form of a stream of symbols, a group of symbol blocks, an N-dimensional key matrix, or any other form usable by the particular encryption scheme.

The random split provides a random component to the cryptographic key. This split is randomly or pseudorandomly generated based on a seed which is provided by any source as reference data. For example, when a user attempts to log on to a system, the date and time of the user's log-on attempt, represented in digital form, can be used as a seed to generate the key split. That is, the seed may be provided to a pseudorandom sequence generator or other randomizer to produce the random split. Such pseudorandom sequence generators are well known in the art. For example, a simple hardware implementation could include a shift register, with various outputs of the register XORed and the result fed back to the input of the register. Alternatively, the seed may be combined, or randomized, with a built-in component, such as a fixed key seed stored at the origination space. The randomization may be performed, for example, by applying a variation of the text/key relation to the generated seed and the stored fixed key seed. This result may be further randomized with, for example, a digital representation of the date and time of the encryption, in order to produce the random key split.

The token split may be generated in a similar fashion. In this case, the seed is provided on a token, that is, it is stored on a medium that is possessed by the user. For example, the seed may be stored on a floppy disk that the system must read as part of the encryption procedure. The token may store a number of different seeds, or label data, each of which corresponds to a different authorization provided by the system or specified by the user. For example, one seed may be used to generate a key split to authorize a particular user to read a message at a particular destination space. Another key seed may be used to generate a key split to authorize any member of a group of users to read a message at any destination space, and for one particular user to read the message and write over the message at a particular destination space. The label data 46 may even designate a window of time during which access to the communication is valid. This seed may be randomized with a built-in component 48, such as a seed stored at the origination space, which may then be further randomized with organization data provided to the organization to which the user belongs.

The console split is derived from a changing value stored at a user space, such as on a system console. Maintenance data, such as the checksum taken from a defragmentation table set, may be used to produce such changing values. For example, the current maintenance data may be randomized with particular previous maintenance data. Alternatively, all previous maintenance data may be randomized with a built-in component stored at the origination space, the results of which are XORed together and randomized with the current maintenance data. The randomization result of the changing value is the console split.

The biometric split is generated from biometric data vectors provided by biometric samples of the user. For example, a retinal scanner may be used to obtain a unique retinal signature from the user. This information, in digital form, will then be used to generate the biometric split. This may be accomplished by, for example, randomizing a digital string corresponding to the biometric vectors with biometric combiner data, which may be a digital hash of the user's system identification number or some other identifying data that can be linked to the user's physical data provided by the biometric reader. The resulting randomized data is the biometric split. The biometric split provides information that is incapable of being reproduced by anyone but the user providing the biometric data vector.

The built-in key split components described herein may be static in that they do not change based on uncontrolled parameters within the system. They may be updated for control purposes, however. For example, the built-in key split components may be changed to modify the participation status of a particular user. The key split component may be changed completely to deny access to the user. Alternatively, only a single prime number divisor of the original key split component may be taken from the key split component as a modification, in order to preserve a legacy file. That is, the user will be able to access versions of the file created prior to the modification, but will not be allowed to change the file, effectively giving the user read-only access. Likewise, modification of the key split component can be effected to grant the user broader access.

Once the key splits have been generated, they may be randomized together to produce the cryptographic key for the communication. In performing each combination to generate the complete cryptographic key, a different variation of the text/key relation may be applied. The use of a plurality of different text/key relation variations adds to the security of the overall cryptographic scheme. It is contemplated that key splits other than those specifically described herein may be combined in forming the complete key. The total number of splits may also vary, and these splits may be used to build a key matrix to add to the complexity of the system. This complete key should be in a form suitable for use in the particular cryptographic scheme. That is, different fields in the key may have different functions in the protocol of the communication, and should be arranged accordingly within the key.

At the destination space, the process is reversed in order to determine whether a user attempting to access a message has authorization, that is, has the valid key. The key supplied by the user at the destination space must include information required by the labels that were used to create the token split at the origination space. This information may also take the form of a token split. Further, a biometric split may be required as part of the destination key, in order to provide a link between assigned identification data for the user and physical data collected from the user biometrically. The token split and the biometric split may be combined with other splits at the destination space to form the complete destination key.

To provide confidentiality, the working key, and thus the associated values (splits), must remain secret. Most values are distributed to members in encrypted member profiles. The unique key used for member profile encryption is derived from information such as passwords, information on a cryptographic token, a member's public key, and, when applicable, biometrics.

Values contained in a member's profile include the domain value, shared by all who participate in the domain, and a maintenance value, which is updated periodically. The maintenance value may also be used to aid in enforcement of member profile revocation.

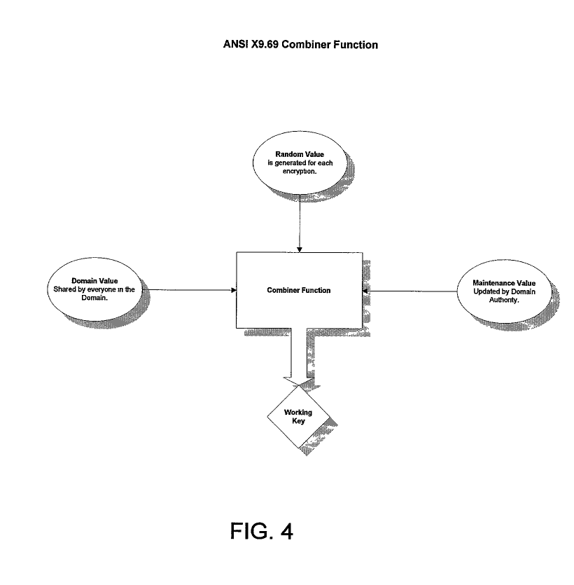

The working key must be a one-time key to guard against sophisticated cryptanalytic attacks and be unique enough so as not to be easily derived or guessed. A random value, generated anew for each object encryption, is used as a third value in the combiner to satisfy these requirements. See FIG. 4.

The job of the combiner function is to create a working key from the maintenance, random, and domain values. This combiner is particularly advantageous for use with applications that have relatively limited resources (such as smart cards).

The internal workings of the combiner function are described herein with reference to the Data Encryption Standard (DES) algorithm, for ease of explanation only. Other symmetric key algorithms may be used in place of DES, in which case operation would be similar to that described for DES. DES is operated in two-key or three-key triple DES Cipher Block Chaining (CBC) mode. The maintenance value acts as plaintext to be encrypted with DES, using the random and domain values as DES keys. The cipher text output of the combiner function is the working key.

The maintenance value is generated by the domain authority, preferably as a 640-bit block. From this block, 512 bits (64 bytes) are presented to the combiner, making the working key 512 bits. Alternatively, the exact size of the key needed for the algorithm chosen for object encryption may be used.

The random value preferably is a 24 byte (192 bit) block and the domain value preferably is an eight byte (64 bit) block. The DES keys—the first sixteen bytes of the random value and the eight-byte block of the domain value—are parity adjusted as for any DES key. The first eight-byte block of the random value is the first triple DES key in the combiner. The eight-byte domain value is the second triple DES key. The last triple DES key is the second eight bytes (parity adjusted) of the random value. The remaining eight bytes of the random value supply the initialization vector (IV) for the CBC mode of triple DES.

Summary

The combiner receives the domain, maintenance, and random values as inputs. A 512-bit maintenance value is encrypted using triple DES in CBC mode initialized with the random and domain values. The result is the working key used to encrypt an object.

Enforcement of read/write data separation is accomplished by encrypting the combiner used, the random value with asymmetric key (Diffie-Hellman) cryptography using the public keys associated with each credential. Corresponding private keys are used to decrypt and recover the random value allowing an object to be decrypted.

Giving a member knowledge of the public key associated with a credential is equivalent to granting that member write-only access to that credential. Giving a member knowledge of both the public and private key grants that member read and write access to the credential.

### Encryption of a Random Value

Introduction

The combiner is the function used to create a working key, that is, the key that will be used for encrypting and decrypting information, messages, etc. A domain value, maintenance value and a random value are inputs to the combiner. The domain and maintenance values are shared by every entity within a specific domain. The random value is a nonce, that is, a one-time use (pseudo) random number generated by the encrypting entity. This number is transmitted with the encrypted message (or stored with the encrypted information) so that a decrypting entity will be able to recover the working key and then recover plaintext.

The random value is encrypted before being transmitted with the cipher text using keys corresponding to credentials chosen by the encrypting entity. The possession of credentials is the basis of access control in the invention. If an entity does not possess the key to a credential, then that entity has no access to objects that have been encrypted using the credential.

A symmetric crypto algorithm key may be associated with each credential, in which case the random value is encrypted using a symmetric algorithm initialized with a credential value. However, this does not allow read/write access separation enforced by encryption.

To realize enforced read/write separation, asymmetric key cryptography is used. A different private and public key pair is associated with each credential. The public part is used during the encryption process and the private part is used for decryption. Many different asymmetric algorithms may be used in implementation of the system of the invention, including a version of Diffie-Hellman key agreement, RSA, and the elliptic curve analog of the Diffie-Hellman method.

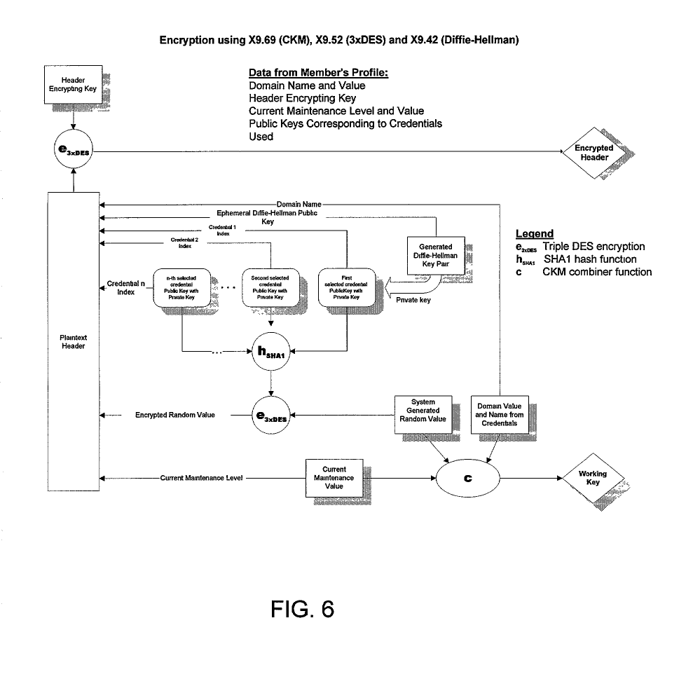

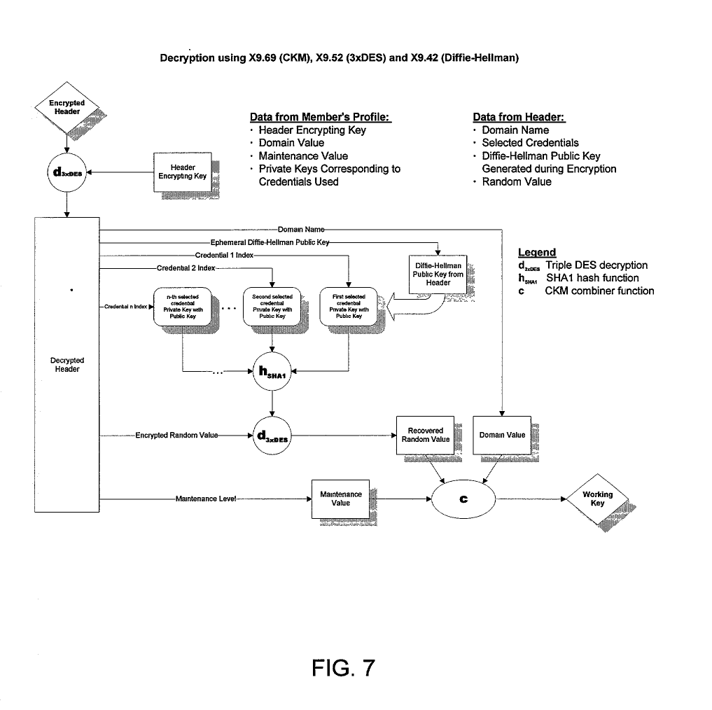

The standard Diffie-Hellman key agreement algorithm and RSA as applied to the invention are discussed below, as exemplary, and not limiting, embodiments of the invention, with reference to FIGS. 6 and 7.

Encryption

Input: Random value (R), public keys associated with selected credentials (y₁, y₂, . . . ), parameters—p, q and g.

Output: Encrypted random value (ER), ephemeral public key (t).

Method:

1. Generate a (pseudo-) random ephemeral private key, r, such that 2≦r≦q.

2. Compute the corresponding ephemeral public key, t, such that: t=g^{r} (mod p).

3. For each public key, y₁, y₂, . . . , yₙ, compute a derived key, k₁, k₂, . . . , kₙ, such that: kᵢ=yᵢ^{r} (mod p).

4. Concatenate the derived keys in order of credential index and hash this block with SHA1: k=SHA1(k₁||k₂|| . . . ||k₃).

5. Encrypt the random value using the value of the hash, k, as the key for a symmetric key crypto algorithm. Call the result ER. If DES or triple DES is used:

a. Adjust parity of every eighth bit in the first 8 bytes of the hashed value, k, for DES, or the first 24 bytes for triple DES.

b. The IV is bytes 9 through 16 of the hashed value, k, for DES or bytes 25 through 32 for triple DES.

6. ER and t are sent or stored with cipher text.

Decryption

Input: Encrypted random value (ER), private keys associated with selected credentials (x₁, x₂, . . . ), parameter (p), ephemeral public key (t).

Output: Recovered random value (R).

Method:

1. For each credential, compute the derived keys, k₁, k₂, . . . , such that kᵢ=xᵢ^{t} (mod p).

2. Concatenate the derived keys in order of credential index and hash this block with SHA1: k=SHA1(k₁||k₂||. . . ||k₃).

3. Decrypt the encrypted random value using the hashed value, k, as the key for a symmetric key crypto algorithm, for example, DES or triple DES. Call this result R. It is the original value of the random value.

4. Use the recovered random value, R, as input to the combiner to recover the working key.

RSA Method of Encrypting and Decrypting the Random Value in the Invention

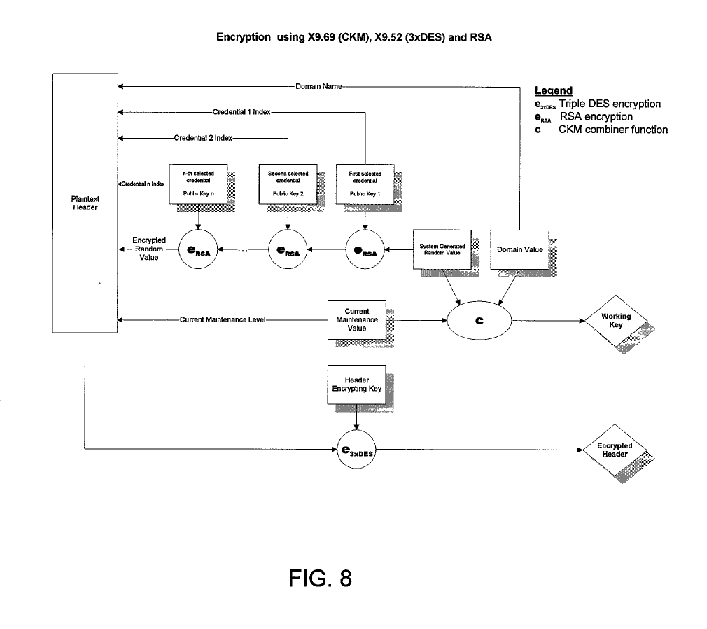

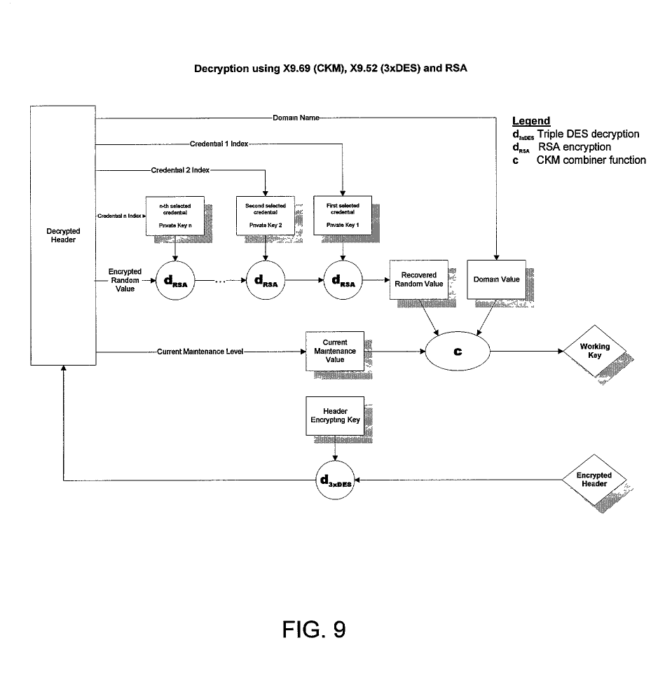

FIGS. 8 and 9 illustrate the RSA method of encrypting and decrypting the random value according to the invention.

Encryption

Input: Random value (R), Public Keys associated with selected credentials (e₁, n₁, e₂, n₂ . . . ).

Output: Encrypted random value (ER).

Method:

1. Encrypt the random value, R, with the first public key, (e₁, n₁), using RSA. Call this ER₁, then ER₁=R₁^{e} (mod n).

2. For each other public key, e₂, n₂, e₃, n₃ . . . , encrypt the result of the previous steps, in order of credential index. For example, encrypt ER, using (e₂, n₂) to get ER₂, etc. The last result is ER.

3. ER and t are sent or stored with cipher text.

Decryption

Input: Encrypted random value (ER), private keys associated with selected credentials (d₁, d₂, . . . ), and parameters (n₁, n₂, . . .)

Output: Recovered random value (R).

Method:

1. Decrypt the encrypted random value, ER with the last private key, dₘ, (where m is the number of credentials used) using RSA. Call this R_{m,} then Rₙ=ER^{d} (mod n).

2. For each other private key, kₘ₋₁, kₘ₋₂, . . . , k₁, decrypt the result of the previous steps in backwards order. For example, decrypt Rₘ with dₘ₋₁ to get Rₘ₋₁, etc. The last result obtained, R₁=R.

3. Use the recovered random value, R, as input to the combiner to recover the working key.

Selecting an Asymmetric Algorithm

When implementation of encrypting the random value using a particular key agreement according to the invention, certain factors should be considered. For example, it is preferable that a new, randomly chosen key pair be used for each encryption session. Even if the same credentials are used again, the actual keys used to encrypt the random value should be different for each encryption session. Use of the same private and public keys repeatedly is contemplated for use with the invention, but is not preferred in most circumstances. The actual algorithm used to encrypt the random value preferably involves the use of a symmetric key algorithm, such as 3DES. This type of encryption has been studied extensively. Further, an algorithm that uses a symmetric key block cipher is preferred, because the encrypted random value can only expand to a multiple of the block size used. In the case of 3DES, this is no more than 7 bytes. In fact, since the random value is 32 bytes, a multiple of the 3DES block size, there is no expansion. Use of an algorithm such as RSA, on the other hand, results in the expansion of the random value to the size of RSA keys used—generally to 256 or more bytes.

### Generation and Use of Symmetric Key Values

Introduction

The invention makes use of values, namely, the domain, maintenance and random values, to derive working keys. A value (key split) is a piece of information used in a combiner function to create a one-time working key. Within a domain, the domain authority (DA) creates the domain and maintenance values and the header encrypting key (HEK). These are distributed to workgroup administrators and then finally to members. Random values are created at encryption time by the system of the invention.

The following describes the generation and use of the domain, maintenance, header encrypting, and random values. Specific exemplary sizes of the keys, and the algorithms used to generate these keys, are disclosed for convenience only, and are not intended to limit the general scope of the invention.

Description

The domain value is used to provide a unique number to be interjected into working key generation. It is what sets the domains apart. This value is distributed to workgroup members in member profiles. In symmetric implementations of the invention, this value is preferably a single DES key and is preferably 64 bits wide.

The random value is created each time a member performs an encryption. It is used in the combiner function to guarantee random, one-time working keys. In a particular embodiment of the invention, a copy of the random value is put into the header. If credentials are applied to the encrypted information, the random value is encrypted using the keys associated with the chosen credentials before this value is put into the header. Symmetric implementations preferably use a 192 bit random value—two DES keys and a DES IV.

Revocation

The maintenance value is used to provide domain-wide change. Reasons for change could include member revocation, key compromise, key expiration, or when a member exits the domain for any other reason. The role of the maintenance value in the combiner function is plaintext, while the domain and random values function as the keys used for the encryption. The output cipher text of the combiner function is the working key. The size of the maintenance value sets the size of the working key. The maintenance value and working key are 512 bit blocks.

The HEK is used to encrypt the header, which contains among other things, pointers to information not included in a member's profile, and is used to reconstruct the working key, for example, the random value and credentials. In exemplary implementations of the invention, the HEK is a 128-bit block—a 2-key, EDE triple DES key. The HEK is also updated periodically along with the maintenance value.

The maintenance value and HEK are distributed in member profiles. Since both are updated at the same time they are generated from the same block of bits—the first 512 bits are used for the maintenance value and the next 128 bits are the HEK. This 640-bit block is updated in such a manner that previous values can be reconstructed from the present value but future values can only be generated by the DA. This allows access to information encrypted using previous values without having to store all of those previous values; only the value and its update index number are stored by members.

Generation

When available, a hardware random number generator is used to generate DES keys. A pseudorandom number generator can be used in lieu of a hardware random number generator.

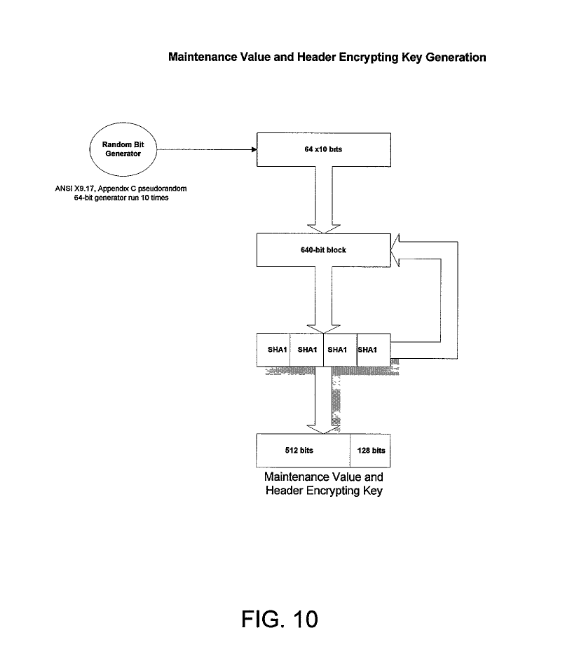

With reference to FIG. 10, the DES algorithm is used in the following exemplary embodiment of the combiner of the present invention. The keys and values are therefore DES keys. The seed for this pseudorandom key generator is a hardware-generated random bit stream, or the seed is generated by some other method of generating a non-repeatable sequence of bits. The DA uses this algorithm for generating the domain value as well as the starting value for the maintenance value and HEK sequence. Member client programs use the same algorithm for generating the random value.

A feature of the maintenance value and HEK is that previous values can be determined by sending the current value through a one-way function. To generate the starting value, the pseudorandom key generator is run a number of times, for example, ten times to generate a 640 bit block. This exemplary block is split into four 160-bit blocks and each of these is hashed using SHA1—the one-way function. The resulting 640-bit block is hashed again a predetermined number of times, for example, 100,000 times total. The first value for the maintenance value and HEK is this last 640-bit block, which is distributed to every member in the domain. This value, as well as the starting value and index, in this case 100,000, is saved by the DA. The starting value must be kept secret.

For the first update, the saved starting value is used and the hash process is repeated, but only 99,999 times. This is update number 1. By applying the hash process to the first updated value, the original value can be recovered by members of the domain. Members of the domain can go back, only the domain authority can go forward. Updates 2, 3, and so on are generated similarly.

Calling the initial index value n (e.g. 100,000), and the update index number, I, the starting value will be denoted by S, the update index by i, and the updated value as Sᵢ. Denoting x applications of SHA1 to a value, A, as SHA1ₓ (A), to generate Sᵢ, the domain authority computes:

Sᵢ=SHA1₍ₙ₋ᵢ₎(S).

A member, given Sᵢ and i, can compute Sⱼ if j<i:

Sⱼ=SHA1_{(i-j)(S}ᵢ).

The maintenance value for update index i, denoted Mᵢ is the first 512 bits of this 640-bit block. The last 128 bits are the value of the HEK for update index i, denoted HEKᵢ.

There is a limit to this scheme as to how many times the value can be updated, depending on the initial index, n. Smaller values for n will reach the limit sooner depending on update frequency. Larger values result in longer calculation times to be performed by the DA at each update. However, techniques such as caching, that is, saving the last, for example, 100 values, can increase performance.

The value for n may be set by the DA at system initialization and should be large enough to cover all updates beyond the foreseeable future.

Use

Each time keying material needs to be updated in the domain, the DA can issue the next maintenance value and HEK. Members need to update to these latest values in order to continue operation in the domain. Distribution of these values is described in documents about credential distribution.

When a member performs an encryption, a working key is constructed from the domain value, maintenance value and a newly generated random value. The random value is placed in the header with the current update index for the maintenance value and HEK. This index value remains in the clear (with the domain name and version number also in the clear) while the rest of the header is encrypted using the current value of the HEK. If credentials are applied to the encrypted information, the random value is first encrypted using the keys or values corresponding to the credentials before it is placed in the header. References to the credentials used are also placed in the header.

Information encrypted using the current value of the maintenance value and HEK can be recovered by directly using the current “updated” values of the HEK and maintenance value. Information encrypted under a previous “updated” value can be recovered by first computing the previous “updated” values of the HEK and maintenance value. ps Summary

The domain value is generated one time by the domain authority. The maintenance value and header encrypting key are generated as a sequence of values by the DA to be updated on a regular basis as the DA sees fit. These three values are distributed to members in member profiles.

The random value is generated as a one-time random key at each message encryption. This value, the domain value, and the current maintenance value are used in the combiner to construct a working key to be used as a message-encrypting key. The random value, after having been encrypted with credentials, if used, is put in the header that corresponds to the encrypted message. The current header encrypting key is used to encrypt the header.

The current (or calculated previous) value of the header encrypting key is used to decrypt the header. The random value is recovered by using credential values. Using the domain value, the proper level of the maintenance value, and the recovered random value will allow for the working key to be reconstructed and the information to be decrypted.

### Pseudorandom Number Generators

Introduction

Secure cryptography requires random numbers. Most commercial cryptographic systems today are implemented in software, although, of course, a hardware random number generator may be used. Given the limitations of software, the best software random number generators can expect to achieve is pseudorandom numbers. The random number generators supplied within high level programming language libraries do not generate random numbers that are cryptographically secure, thus special techniques need to be used. The following describes processes used by the system of the invention to generate sequences of pseudorandom numbers for use in software-implemented cryptographic systems.

The system of the invention uses pseudorandom numbers in several different processes, for example, generating random values to use in the combiner; generating ephemeral Diffie-Hellman key pairs for random value encryption; generating DSA per-message secrets for digital signatures; generating the domain value; generating maintenance value sequences; generating domain-wide DSA and Diffie-Hellman parameters; generating Diffie-Hellman key pairs for credentials; generating DSA global key pairs for digital signatures; and generating DSA and credential distribution.

The first three processes are used repeatedly during daily operation of the invention. The next five processes are primarily used by a domain authority for system initialization. The last process is used during member enrollment.

Random Bit Collection and Initialization of Algorithms

Pseudorandom numbers can be generated by taking a relatively random starting point (seed) and processing it according to an algorithm, which will manipulate the seed to produce pseudorandom numbers. The strength of this process depends in part on the randomness of the seed sent to the algorithm. In order to get the best possible randomness, the process should gather as many random bits as possible for use as the seed. There are many ways to collect random bits for a seed. The following is a partial list of some pieces of information that can be used as random bits for the seed: Time between key strokes; mouse movement (speed between two random points, time between clicks, coordinates at random time intervals, etc); system time (either in clock ticks or elapsed time since a reference time); white noise generator (usually a hardware device); random bits from network packets; and user ID and password.

Depending on the operating environment, the system of the invention will collect as much random information as possible from a mix of these sources to use as inputs into the processes described below.

Seed generation is performed once at system session startup, that is, logon. The pseudorandom number and bit generation algorithms are all initialized with this seeding material and run to generate 20,000 bits of pseudorandom data.

### The Encryption Process and Digital Signatures

The Encryption Process

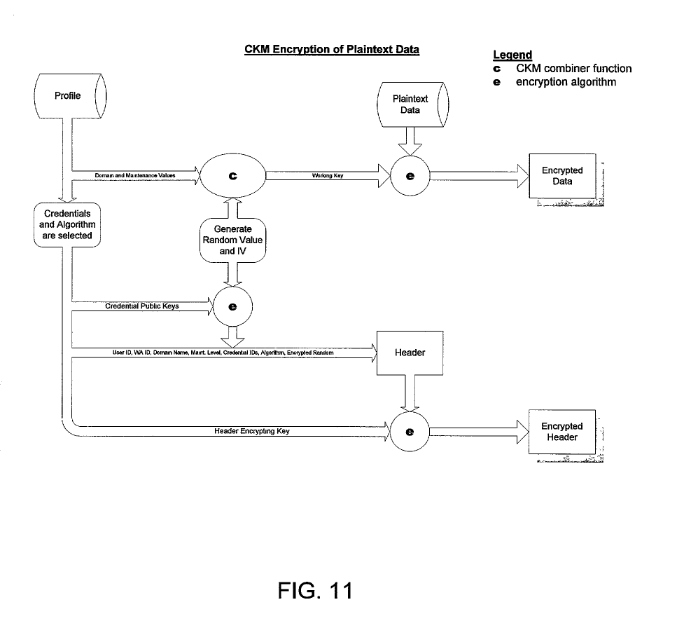

The working key is constructed from the combiner process as previously disclosed. As illustrated in FIG. 11, the working key is used with an encryption algorithm such as DES or AES to encrypt plaintext data. The exemplary working key is a 512-bit symmetric key that will need to be adjusted for the encryption algorithm input bit requirement. As an example, for DES, the working key may be truncated to 64-bits, or 56-bits if no parity is used. Other methods may be used to adjust to a symmetric encryption algorithm. This process of plaintext and key being applied to an encryption algorithm results in encrypted data. In addition to the encrypted plaintext data, an encrypted header is created. The header is encrypted with the header encrypting key using a standards-based encryption algorithm. Prior to encrypting the header, various data is assembled including a binding process that ties the encryption of the combiner's random value with one or more asymmetric credentials. The encryption process is illustrated in FIG. 11.

Encryption with a Digital Signature

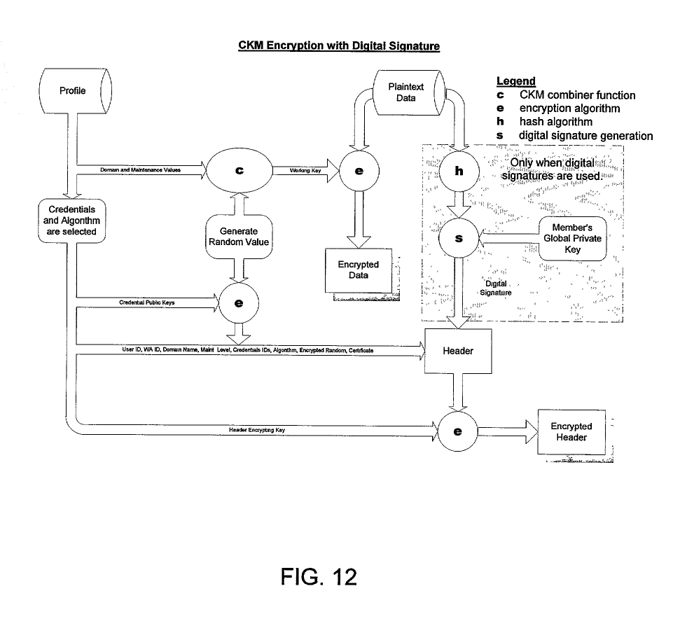

In addition to signing the data for confidentiality, there may be a requirement for signing the data to ensure data integrity and authentication of the sender. A digital signature provides for a cryptographic transformation of a data unit that allows a recipient of the data unit to prove the origin and integrity of the data unit and protect the sender and the recipient of the data unit against forgery by third parties, and the sender against forgery by the recipient. A digital signature consists of a two-part process: a hash of the data is executed, followed by an asymmetric encryption of the hash. The asymmetric encryption can be based on, for example, RSA or Diffie-Hellman. The global member key in the following example is designated as RSA-based, for ease of explanation, and is not a limitation of the invention. Note that the global private key is used for encryption, and the global public key is used for decryption. The resulting digital signature is added to the header prior to encryption of the header. FIG. 12 illustrates the signing process using a digital signature.

The Decryption Process

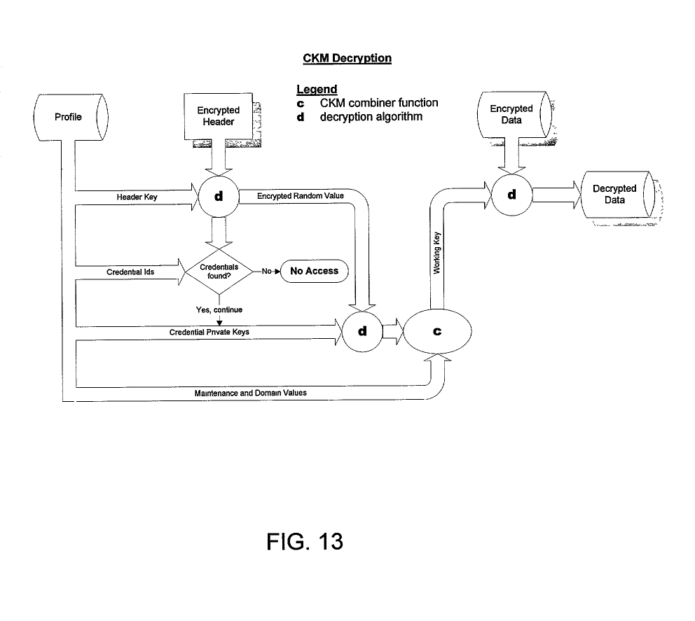

As illustrated in FIG. 13, the process of decrypting data includes a profile, the encrypted data, and a respective encrypted header. The profile includes the credentials, values, and header key to reconstruct a working key that is used to decrypt the data.

Decryption with Digital Signature Verification

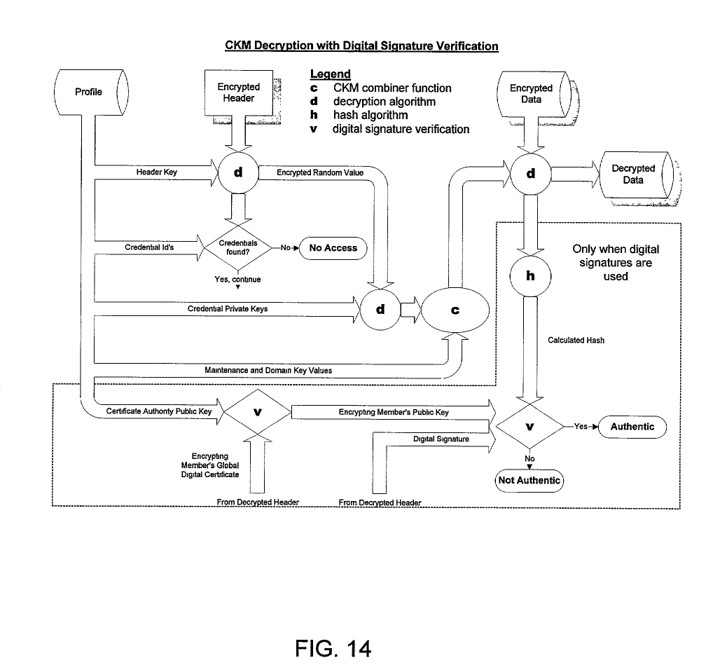

A working key is reconstructed and used to decrypt the data. The decryption process may be viewed as an initial process prior to the verification process. The digital signature verification process includes a global public key that is included in the member profile, an encrypting member signed certificate from the decrypted header, a digital signature from the decrypted header, and a calculated hash of the encrypted data. The verification processes may use, for example, RSA or DSA. The certificate authority public key is used to verify an encrypting member's global digital certificate and to extract form the certificate the encrypting member's public key. The combination of the calculated hash, the digital signature, and the encrypting member's public key is used to verify that the encrypted data's integrity has been maintained and a designated member had signed. FIG. 14 illustrates the verifying process using a digital signature.

### Member Revocation

Introduction

To ensure private communications between two or more parties requires all parties involved having some type of related information that is kept private. In the environment of the system of the invention, the private, shared information piece is the value (referred to as values) associated with each of the domain values and the maintenance values. Every message encrypted using the invention is encrypted using the maintenance value as one of the inputs into the combiner. The other inputs are the values associated with the credentials, which the member has chosen. Since the encryption method used for the invention is symmetric, if a member needs to be removed from a workgroup, at least one piece of information needs to be removed from the member or altered.

Objective

To outline a strategy for revoking a Member's Profile.

Network Revocation

Access control is based on possession of values used as keys for encryption and decryption of information.

Each member can have multiple profiles. A profile is the member's permission set, that is, the credential values, their associated credential names, and indices that can be used for encryption (write permission) and decryption (read/write permission), and the permissions to the algorithms that may be used. In addition, the domain name and associated value, maintenance level and associated value, header encryption value, and certain parameters to be used by the domain are contained in a member's profile. Policies, such as minimum password length, are also included in the member profile. When digital signatures are used, a copy of the entire domain's workgroup administrators' public keys are included, as well as the member's signed certificate.

Each of the credentials can be used for separate functions such as multiple network-bound credentials and multiple credentials used when there is no central network server. Two examples of network-based credentials are an ATM card network and a corporate network. Any credential used without a central network is referred to as stand-alone (no network connection). In this sample situation, one of the values for the ATM and corporate network credential will be stored on the ATM server and corporate server respectively. With the maintenance value for these two credentials on a network server, the domain authority could instantly revoke the entire system by changing this one value. Each network member will need to use this new value within the specified revocation time period. The domain authority can configure the revocation time period. Once the new value is updated, the old value cannot be used to encrypt any new resources, although the old value can still be used to decrypt older resources. See the value generation section below for more information on how the maintenance value is generated.

In order to protect the integrity of a revocation, the maintenance value must be protected. One method to reinforce integrity for the maintenance value is as follows. Each member will have a public/private key pair. When a member opens a session, the system of the invention will contact the closest server to request the latest maintenance value. When the member contacts the server, the server will respond with a challenge string (incremental or random number/string). The member must sign the challenge within a specified time period of the server generating it to prevent replay attacks. Once the server authenticates the member as being an active member, and the server verifies the signature on the challenge, the server then encrypts the latest maintenance value with the member's public key and sends the response back to the member. At this point, the member then has the latest maintenance value for use within the invention. The member will cache this value until the session is closed, at which time the maintenance value is destroyed. As an option, the domain authority, (and in turn the workgroup administrator) may provide the ability to store the maintenance value across sessions by storing the value on the smart card. This will allow the member to fall back to a possibly out-of-date maintenance value for use when the network repository is not available.

An alternative process is to revoke the global certificate based on an available certificate authority (CA) architecture. A predominant commercial model for CA management is through a PKI. PKI is used to provide a trusted third party network to authenticate users and to issue, manage, and maintain their digital certificates. Digital certificates, based, for example, on international X.509v3 standards, contain public and private keys that are based on public key encryption algorithms. Exemplary global certificates employed in the system of the invention are based on RSA digital signatures and certificates. A smart card or token would store the public global certificate and employ the certificate for authentication within the network. The token would be a bridge for multiple CAs in that more than one certificate can be stored on a member's token. Two potential methods would be available for revoking the global certificate:

1. Within the PKI architecture is an optional certification revocation list service through which the certificate for a specific member can be deleted and a posted notification done for other users. To be effective, a periodic access is needed to the listing service, or

2. Delete the global certificate from the token through a protected software command. Note that the certificate resides in volatile memory of the token and can be remotely updated and deleted.

The server application should be replicated across multiple network servers for redundancy and to help thwart denial of service attacks. Details of generating and managing the maintenance value have been previously discussed.

Value Generation

In order to limit the number of values that need to be stored, the old maintenance value can be derived from the current value, but future values cannot be derived from the current value. The domain authority will generate x number of values using the first value as the starting point. The first value to be used will be value n. When a revocation occurs, the next value will be n−1. Given n−1 and the relationship used to generate n from n-1, the current value can always be used to generate n. Since values will be issued from n down to n−m, the earlier values in that sequence will always be recoverable. At a point in time when n−m has met the domain authority's threshold, a new sequence will need to be generated. In this scenario, the last value in the sequence, n-m, will need to be accessible for decryption only. For example, the domain authority decides a sequence of 1000 values is sufficient. The first value placed on the network server it value #1000. When a member is revoked, the value is compromised, or the value has expired, the domain authority will update the value on the network server to value #999. This will continue until the value reaches #1 or the domain authority decides to update the sequence. Once this occurs, the domain authority will generate a new sequence of 1000 values and start over again from 1000.

The domain authority generates the values in such a way that if the member knows value # 500, he can figure out any value from #501 to 1000 (using the previous example). Value #1 is generated using a random key generator. The next value, value #2, is generated by sending value #1 into a secure hash process. The result from hash process will be value #2. Taking the hash process results using value #2 as input, generates value #3. This eliminates the need to store each of the old values to decrypt older messages.

A Member-Oriented Revocation

A global digital signature (DS) would be stored on the token like a certificate. In lieu of a full X.509v3 certificate, the member's public function of a digital signature and a bound name would be used to authenticate the member throughout a network. The binding technique could include a relationship to a business entity or a functionary relationship to a closed domain. The global DS includes a hash of the object and a public key encryption of the hashed object. The trust would be built through an enhanced member identification model that binds one or more member associated identity traits (biometrics, pin or password, or possession of a unique number such as a token number) with an encrypted virtual container. The container would include access credentials, the global DS, and other private key elements. The trust would be a series of binding relationships that link the member to information, an account, or another form of an object.

A member would register his or her global DS with an account. The global DS would be used for signing and verifying selected objects such as a file. If the file requires confidentiality, the invention would be used in lieu of the Global DS.

The global DS can be revoked at the token level through an encrypted remote access and deletion. If the global DS is available at a server, it could be deleted at that point.

Stand Alone Revocation

In the case of the stand-alone member, there is no instant method of revoking keys. The domain authority can issue a new maintenance value similar to the network environment. The difference is the change is not instantly propagated throughout the system. Since there is no network server, the new value must be encrypted using the member's public encrypting key and transmitted to the member via e-mail, floppy disk, etc. All non-revoked members will receive (or retrieve) the message that the changes have been made and the new value is attached.

The Header

The general header object of the invention is used to carry information about the encrypted objects. It usually contains the signature, a header version, a domain name, credential indices, a random value (encrypted using credential public keys), a maintenance level, a crypto algorithm ID used to encrypt message, an encrypting member's ID, an ID of authority that issued the encrypting member's profile, an identifier of digital signature and certificate system used, a member's signed certificate (if digital signatures are used), and a digital signature of message (if digital signatures are used).

The header, with the exception of the first three items listed above, which remain in plaintext, may be encrypted with the header encrypting key unique the domain.

Some of the fields are of varying size but most are constant. The fields that are generally of constant size are designed to accommodate the largest values that the field would conceivable contain. However, depending on the application, some of the header fields can be smaller, reducing the overall size of the header. In some cases, certain data may be assumed to have constant value. Constant values may be left out of the header altogether, further reducing its size.

The “Signature”and “Header Version”fields are usually of constant size. In some cases, the fact that this object is the header is implicit within the applications, in which case these fields need not be present in the header object.

The “Domain Name”is usually several characters, however, in some applications this field may be represented with an integer. This could reduce its size to one, two, or just a few bytes of data.

Credential indices depend upon the number of credentials used within a domain. Each index could be represented with one, but usually more, bytes. The size of the data representing these fields is also dependent upon the number of credentials used. This number may be constant.

The random value is usually a 512-bit number, large enough for most symmetric key algorithms. If, however, it is assumed that only one algorithm will be used for the encryption of objects, the random value may only be large enough to accommodate the algorithm. However, this random value is encrypted using keys corresponding to the credentials chosen. The final size of this encrypted number depends upon the algorithm used for this. If asymmetric key encryption is used for random value encryption, the encrypted random value may be much larger, depending on the type of asymmetric key algorithm used and the size of the public key (the modulus). For example, if RSA is used, the size of the encrypted random value would generally be on the order of the size of the modulus used (part of the public key). Elliptic curve methods generally allow smaller keys, and therefore allow a smaller encrypted random value. If symmetric key systems are used, this encrypted number can be even smaller. A variation of Diffie-Hellman key exchange can be used to generate the keys used with symmetric key systems. This system would add a Diffie-Hellman public key to the header, but would otherwise not expand the size of the encrypted random value or the header.

The maintenance level is usually a two-byte number, allowing approximately 65,000 “steps”of the maintenance value. If it is anticipated that this value need not be updated very often, then one byte (or 256 steps) may be sufficient.

The “Cryptographic Algorithm ID” field will typically be one byte. If only one data encryption algorithm is used within an application, this ID may be left out of the header.

For some applications within a closed domain environment, credentials may represent the identity of a person or entity. In this case, the encrypting member's ID may be left out of the header since the identity can be assumed from the credential index. The ID of the authority issuing a profile to the member may similarly be left out. The private keys corresponding to these members or entities will be used to encrypt the random value. This will supply member and message authenticity for the application.

Note that digital signatures are an optional feature of the invention. Also note that if credentials represent member or entity identification, then digital signatures are not needed for member authentication.

Based upon this information, a minimum size for the header can be calculated. This is based on the assumption that applications that use the invention form a closed system where it is assumed that all applications within the system use a common format for encrypted data, encrypted data is only used within one particular domain, credentials/profiles are used to represent members or other entities, and algorithms used for encryption are implicit in the application

The Signature, Header Version, Cryptographic Algorithm ID, Member's UID, The UID of the Member's Workgroup Administrator, and Digital Signature fields may be left out. The size of the header will depend on the number of credentials used, and the algorithm used to encrypt the random value. Assuming that the credential indices are represented with four byte integers and two credentials are used (representing two parties), the credential indices field contains eight bytes. For example, using RSA with a 768-bit modulus requires 96 bytes for the random value. The maintenance level adds one or two more bytes for a total size of approximately 106 bytes for the header.

If all encrypted communications are to take place between a central entity and the domain's members, then, instead of asymmetric key, symmetric key systems can be used to encrypt the random value. Using single DES in this case would bring the total size of the header down to 18 bytes.

Administrative services in the system of the invention may be handled by an Administrative Service Provider (ASP). The ASP includes a library of all administrative methods needed to create and maintain a system, and an application programming interface (API) to these functions. Through its use of a service provider, the system of the invention offers maximum flexibility to tailor administrative services to the precise needs of a wide variety of organizational structures and applications. Areas of customization include the following:

N-Tier Distribution. Administrative functions may be separated into as many levels as needed for security and workload needs. Organizations may continue to use the 3-tier system consisting of a domain authority, workgroup administrators and workgroup members, or they may customize this system for more or less separation of functions and levels of distribution. Other organizations may opt to develop a fully customized system implementing services in an entirely different way.

Automation. Some or all administrative needs may be automated to increase application efficiency and member productivity. An account creation application, for example, could automatically add a new customer to a workgroup and create his or her member profile. Similarly, automated credential renewal and distribution applications could be scheduled for network-based systems.

Flexible Role and Responsibility Assignment. Administrative roles and responsibilities are not bound, a priori, to any level or component. If the standard role assignments of domain authority, workgroup administrator and workgroup member do not meet an organization's needs, applications may be customized for other assignments. Responsibilities may be moved up or down the distribution hierarchy, or roles may be assigned in a completely different manner.

The level of flexibility offered by the system of the invention can prove extremely beneficial to organizations with specialized needs.

Administration Concepts

Administration according to the invention is based on several core concepts that apply to any set up—even if some are made to be transparent. This section provides an introduction to each of these critical concepts. Additionally, concepts that are not strictly required but which are very common and which aid in understanding the invention administration are also discussed.

Domain

The highest unit of organization in a system is the domain. A domain is a unique, independent entity that includes all the invention resources needed to function on its own. Policies, procedures, and roles are all determined at the domain level.

Although it is the largest unit of organization supported within the invention, domains are fully scalable to a wide variety of needs. A domain may be as large as an entire enterprise or as small as a single member. A personal application might, for example, establish a unique domain for each member installation, while small businesses would likely establish a single domain for the company, and large enterprises would establish many domains (for major divisions, different locations, or other organizational structures).

Similarly, while domains are freestanding and independent, they do not need to be isolated. Domains may share access rights and privileges with other domains in a trusted relationship. Additionally, members may participate as members of multiple domains even if a trust relationship between the domains has not been established.

Trusted Domain Relationships

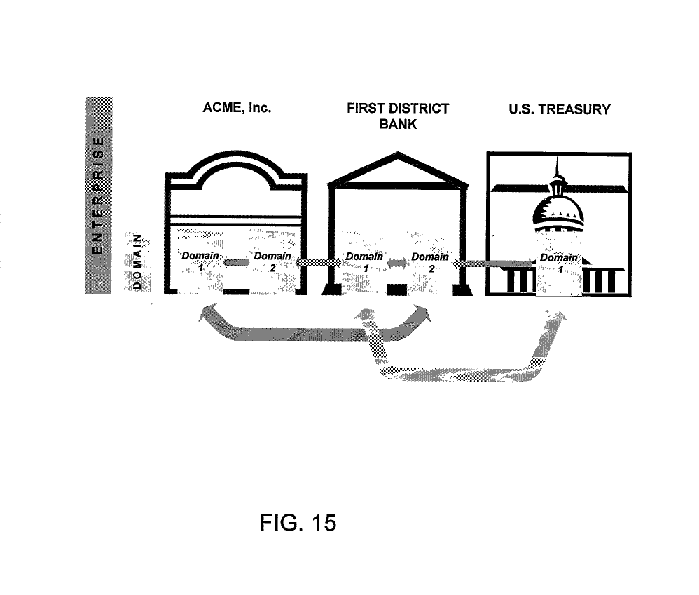

A domain may provide specified access rights and privileges to members of another domain by establishing a trust relationship. As depicted in FIG. 15, the trust relationship is established when one domain provides a subset of its credentials to another domain. Credentials are shared only at the domain level and may not be sent directly to members of another domain. Instead, once trust has been established, the second domain maintains and distributes “imported” credentials using its own methods and policies, and these credentials are stored in the same member profile as the member's normal credentials. Once distributed, members of the second domain may use the imported credentials to share information with members of the external domain, but they continue to be bound by the policies and procedures of the domain in which they hold membership—their logon domain. Untrusted Domain Relationships

An individual may be a member of several domains regardless of whether the domains have established a trust relationship. That is, two or more domains may grant membership independently to the same individual. In this case, the invention sees the single individual as several members—one for each domain. One might say that a member's “system first name” is her user ID, and her “system last name” is the name of the domain to which she logged on. In this type of untrusted relationship, the member will log onto each domain independently, use separate member profiles for each domain, and be provided credentials to access information only within that domain and with its trusted domains.

Domain Authority

The domain authority (DA) provides top-level management to a domain. Although some decisions must be made by the person or persons assuming the responsibility of the domain authority, many DA functions may be automated.

Typically, the domain authority sets up the domain by performing the following functions:

Names the domain and creates its unique domain value (used in cryptographic functions)

Establishes and updates a maintenance value (used for revocation and to update cryptographic values);

Sets policy defining the outer parameters of system use;

Establishes and digitally signs the role-based credentials used by the invention to cryptographically enforce access control to information;

Selects and optionally renames the cryptographic algorithms available in the domain;

Selects and configures identification & authentication objects available in the domain;

Registers workgroups and their administrators through which credentials are distributed;

Digitally signs individual membership keys and authorizations related to enrollment;

Registers and digitally signs applications; and

Creates and distributes workgroup profiles defining a subset of credentials, algorithm permissions, and policy settings available to each workgroup.

The system of the invention allows members to receive credentials, policy settings and algorithm permissions only if signed by the domain authority—even if some of these values are imported from other domains. Members are bound to the domain authority via the DA's membership key issued to the member. The DA's membership key is then used to verify the DA's signature when receiving credentials and related material.

Domain Profile

A domain profile refers to all credentials, policy settings, and algorithm permissions established by the domain authority and available within the domain. The domain profile also includes the domain's name and value, the maintenance value, and other information identifying the domain.

Workgroups

A domain consists of at least one and usually several workgroups. A workgroup is a mid-level organization that clusters members (or smaller workgroups) based on common needs and rights to information. Workgroups are often established to parallel departments, locations, projects or other natural organizational subdivisions.

Workgroup Administrator

Workgroups are typically managed by a workgroup administrator (WA). The responsibilities performed at this level may be by a person interacting with software, or may be automated in part or in full. These responsibilities typically include the following:

Refining policy settings to provide further restrictions than those granted to the workgroup;

Registering the individuals who become the members of the workgroup;

Assigning subsets of credentials and algorithm permissions available in the workgroup profile to individual member profiles; and

Signing and distributing member profile updates to workgroup members.

Workgroup Profile

The workgroup profile contains all credentials and algorithm permissions available for distribution to the members of a specific workgroup. It also includes the policies governing the workgroup's use of the invention. Workgroup profiles may differ from other profiles in the same domain—defining the unique rights and needs of each group. Workgroup profiles are normally created by the domain authority.

Member Profile

A member profile includes the credentials, algorithm permissions, and enforced policy settings assigned to an individual by a workgroup administrator. The member profile also includes the individual's private membership key used to decrypt profile and other membership information sent to the individual. The member profile includes the membership keys of the domain authority and workgroup administrator to which the member is assigned. It may optionally include one or more global private keys and digital certificates used for encryption or signing in other cryptography systems.

Members may receive profile and membership information from the single workgroup administrator whose membership key has been issued in the member profile. All updates to member profiles are signed by the workgroup administrator and must be verified by the WA's membership key held by the member.

Members may be assigned to a different workgroup administrator only by receiving a new WA membership key signed by the domain authority. Additionally, credentials may be updated or added to the member profile only if signed by the domain authority and verified using the DA's membership key held by the member.

In this manner, each individual is bound to a specified workgroup and a specified domain.

Membership Keys

All persons participating in a system according to the invention are associated with a unique pair of asymmetric keys known as membership keys. These keys are used to insure the privacy, authenticity and authority of profiles during the profile distribution process.

Global Keys

The system of the invention provides the ability to interact with other cryptographic and verification services through a global key. The global key is an asymmetric key generated by the invention or supported third-party certificate authority (CA) products or services. When desired, it is used by the invention to digitally sign encrypted information—providing member and message authentication. It may also be used by third-party applications that implement the PKCS 11 standard.

The Enrollment Process

Prior to using the system of the invention, members must be enrolled in their domain and workgroup so that profiles may be distributed, installed, and updated in a secure manner. Although enrollment is the most difficult process in system administration, it need be performed only when adding new members to a domain, and when re-assigning members from one domain to another.

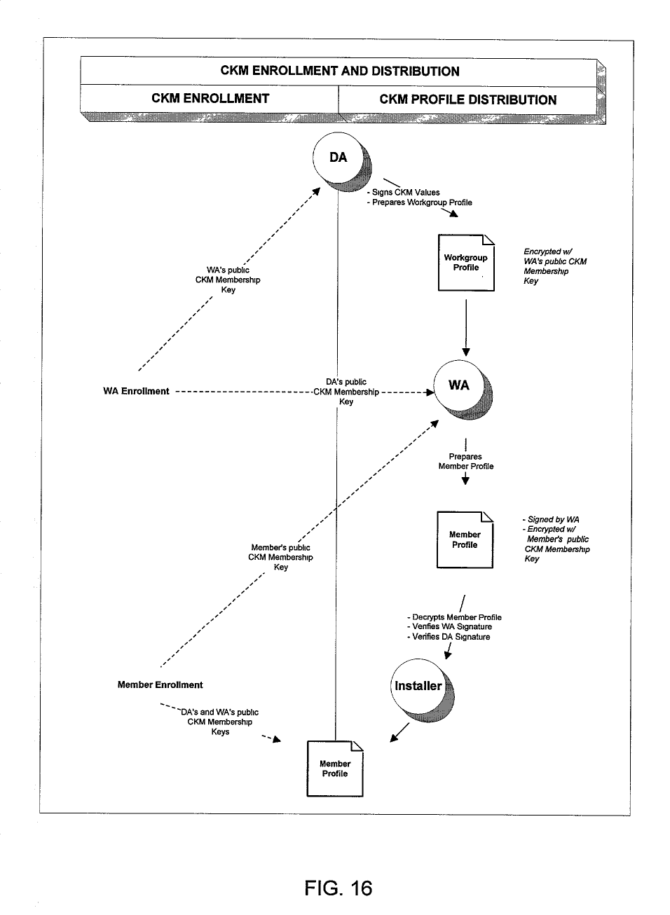

The enrollment process may be customized to meet the precise needs of an organization and is, indeed, different depending on the medium used to store the member profile. Some organizations may prefer, for example, to distribute initial member profiles and global keys during enrollment. Many may wish to maintain total privacy of private keys rather than distribute them. In nearly all cases, however, the enrollment process involves a few basic activities and uses standard processes. The implementation of these activities and processes in a typical system of the invention is used to provide an example of the enrollment process, as depicted in FIG. 16.

Enrollment Basics

In general, enrollment is the process of generating and distributing membership keys so that profiles may be distributed in a secure manner. The enrollment process provides the means to protect the privacy and authenticity of member profiles, and insures that they are being issued by authorized administrators.

Insuring Privacy

Each member's membership keys are generated during the enrollment process either on the member's PC or, if available, on a Java card or other token to be issued to the member. The private half of the membership key pair becomes part of the member profile, whereas the public half is distributed to the member's workgroup administrator. From then on, the workgroup administrator encrypts each installable member profile or profile update with the member's public membership key such that it may be decrypted only with the private membership key held by the member.

Similarly, if the member also serves as a workgroup administrator, the public membership key is sent up one level in the distribution hierarchy—typically, to the domain authority. The DA then encrypts each installable workgroup profile or workgroup profile update using the WA's public membership key.

It is only necessary to distribute public membership keys to the administrator one level up in the distribution hierarchy. The membership key is of no use to any other administrator or member. Therefore, to maintain scalability, system designs incorporating a central directory or repository for public membership keys preferably should be avoided, but may be used with the system of the invention.

Insuring Authenticity

The system of the invention provides independent protection of the authenticity of credential values and other secret information to be installed in a member profile, and of the member profile itself.

When generating credentials for the domain, the domain authority process uses the DA's private membership key to digitally sign each credential value and other secret information. Similarly, credentials imported from external domains are re-signed by the current DA. These signatures are maintained throughout the distribution process to the point of installation of each value in the workgroup or member profile. The values will be installed to the profile only if the DA's signature is verified. The procedure provides all of the following protections:

Insures that the member may use only credentials created or properly imported into the domain to which the member belongs.

Insures that all credentials used in the domain are authorized by the domain authority.

Insures that unauthorized credentials may not be inserted into profiles at any point in the distribution process—from DA to WA, WA to member, or other customized routes.

Additionally, the administrative system provides the ability for installable member profiles and member profile updates to be signed by the workgroup administrator process. Verification of this signature at the point of installation by the member insures that the entire package received by the member is identical to that sent by the WA. This verification insures that the member profile will include all the credentials, algorithm permissions and policy settings assigned to the member by the WA, and only those assigned. The signature will not be verified if the package is changed in any way—even if added credential values are properly signed by the DA (for use by others in the domain) but not intended for this member's use.

Insuring Distribution Authority

Although authentication could be insured by including a certificate with the profiles distributed, this method is preferably not used in an administrative system according to eth present invention. Instead, to insure that profiles are distributed only by authorized agents, the system of the invention preferably uses stored verification keys.

The enrollment process distributes both the DA's and WA's public membership key to each member. Rather than use an included certificate, these stored verification keys should be used to verify signatures prior to installing or updating profiles. Using the public membership keys of the DA and WA held by the member provides the following protections:

Insures that workgroup administrators may receive workgroup profiles and profile updates only from the domain authority to which they are assigned and from no other domain authority.

Insures that members may receive member profiles and profile updates only from the workgroup administrator to which they are assigned and from no other workgroup administrator.

Insures that the credentials and other secrets contained within member profiles are authorized only by the domain authority to which the member belongs and by no other domain authority.

In order to enforce distribution authority, it is required that neither the DA's nor the WA's membership key held by the member may be changed casually. That is, barring specified and strict exceptions, the DA and WA stored verification keys held by the member cannot be changed.

Order of Enrollment

The order followed to enroll members assuming different administrative roles in the system of the invention is critical. In general, members preferably are enrolled beginning at the top of the administrative hierarchy, and proceeding down each level in a direct order, as follows:

1. Enroll the domain authority

2. Enroll workgroup administrators

3. Enroll members

Depending on the security requirements of the organization and the type of media being used for member profiles, the steps needed to accomplish this direct order of enrollment might not follow such a simple sequence. In fact, when not using the Java card, the process must go out of sequence to maintain full privacy of private keys. It is, therefore, important to plan an enrollment system to match the organization's security needs and the system configuration.

Enrollment Using Java Cards

The use of the Java card provides a very simple and direct enrollment process. Because the private membership key is generated on the card and never leaves the card, issues regarding its level of privacy are rendered moot even if generated by someone other than the member. The person or process generating the membership key is given the public half of the pair, but has no access to the private half.

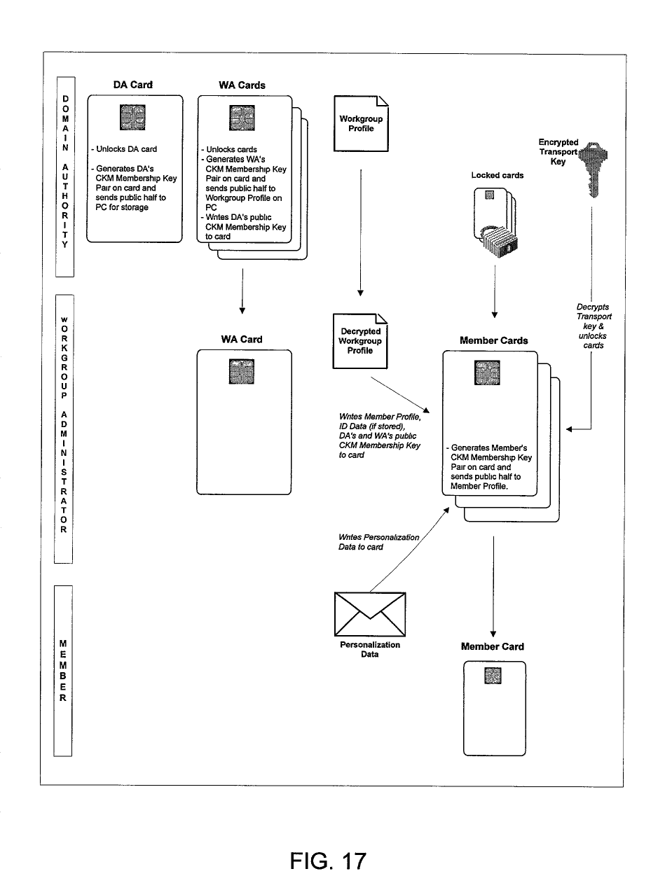

This special capability of the Java card allows members to be enrolled fully by the administrative agent one level higher in the distribution hierarchy. In a standard implementation, that is, domain authorities may enroll workgroup administrators, and workgroup administrators may enroll workgroup members. This process is illustrated in FIG. 17.

Initializing the Java card

Although providing a more direct method of enrollment, the Java card does require an additional step—namely, an initialization process. This process involves the initial distribution of blank cards and the installation of applications.

The Java card is a dually-owned format. The first owner, known as the issuer, is the organization that issues the card, such as a bank or service organization. The second owner is the entity that controls the use of applications on the card—this may be an employer, membership organization, or the individual.

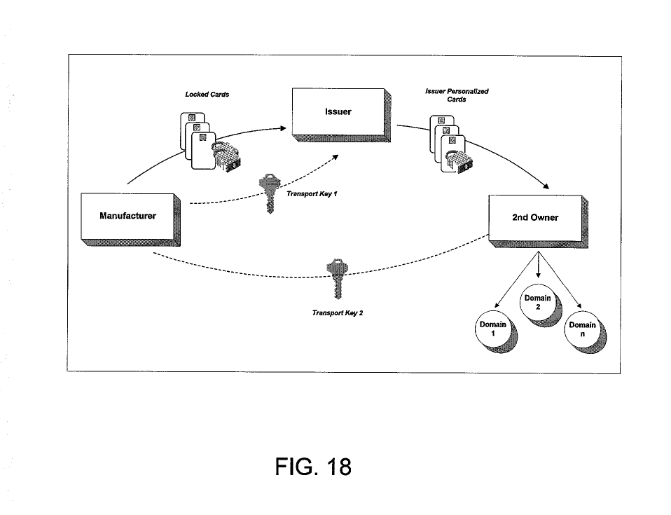

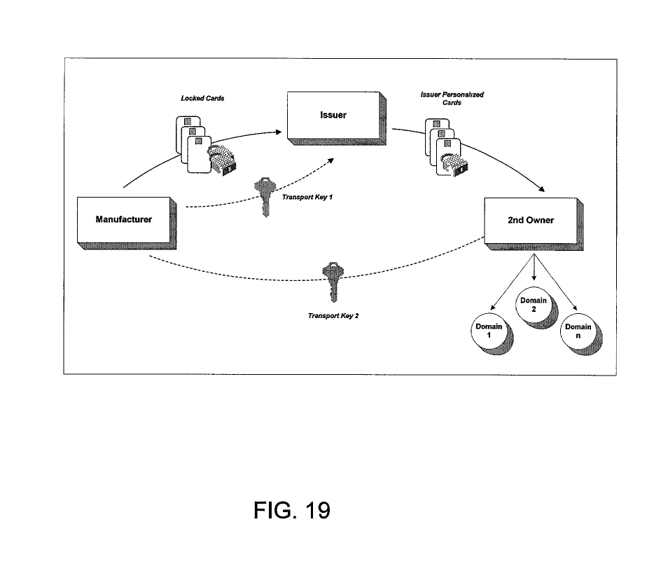

As illustrated in FIGS. 18 and 19, the Java cards are preferably delivered to the issuer in a double-locked state—nothing may be installed on a card until it is unlocked. In this initial locked state, a portion of the card intended for issuer applications is locked with a transport key sent to the issuer separately from the cards. Another portion of the card is locked by a different transport key sent to the second owner directly from the manufacturer or through the issuer.

On receiving the Java cards from the manufacturer, the issuer uses the first transport key to unlock its portion of the card and installs all issuer applications. The issuer may also personalize the card in accordance with its own policies and practices. With the remaining area of the card still locked, the issuer delivers the cards and, if needed, separately sends the second transport key to the second owner.

Enrollment

When using the Java cards, each administrative agent of the second owner enrolls all members at the next level for which they are responsible and distributes initialized cards to them. That is, domain authorities enroll all workgroup administrators within the domain, and workgroup administrators enroll all members of the workgroup. This process was illustrated previously in FIG. 17.

Enrolling Domain Authorities

If the second owner's enterprise includes more than one domain, a trusted officer distributes a sufficient number of cards to the domain authority of each domain. Since these cards are locked, however, the trusted officer must first use the second transport key to unlock a card intended for each of the DAs. The trusted officer then enrolls all DAs and distributes their cards and the transport key in the same manner as DAs do for workgroup administrators, as described below.

Enrolling Workgroup Administrators

In the enrollment process, the domain authority is responsible for enrolling workgroup administrators and providing them the keys they will need to enroll members. To meet these responsibilities, the domain authority performs each of the following actions:

1. If not already enrolled by a trusted officer, the DA unlocks his or her own card using the provided transport key. He then generates his or her own membership keys. If already enrolled by a trusted officer, the DA decrypts the transport key using his or her own private membership key on the provided card.

2. The DA uses the transport key to unlock a card for each workgroup administrator in the domain.

3. The DA generates the membership keys on each WA's card. The private membership key is retained confidentially on the card, while the public membership key is added to a database or directory maintained by the DA.

4. The DA installs his or her public membership key on the WA's card.

5. The DA signs the transport key with his or her own membership key, and encrypts it using the WA's public membership key. The transport key is delivered to each WA through a different channel than the WA cards.

6. The DA distributes each WA card and a sufficient number of locked cards for workgroup members.

Optionally, the DA may create and distribute workgroup profiles as part of the enrollment process.

Enrolling Workgroup Members

Each workgroup administrator is responsible for enrolling the members of the workgroup and distributing an initialized card to each member. To accomplish this objective, the workgroup administrator performs the following actions:

1. Decrypts the provided transport key using her own private membership key on the initialized card provided by the domain authority.

2. Verifies the authenticity of the transport key using the DA's public membership key on her own card, and unlocks member cards using the decrypted transport key.

3. Generates the member's membership keys on the card. The private membership key is retained confidentially on the card, while the public membership key is added to a database or directory maintained by the WA.

4. Installs the DA's public membership key to the card.

5. Installs the WA's own public membership key to the card.

6. Distributes prepared cards to each member.

The workgroup administrator may also perform several optional functions as part of the enrollment process. The initial member profile may be created and written to the card at this time, and card applications may be installed. Any identification objects in addition to the membership key, such as UIDs, PINS, biometrics, and/or passwords, should also be installed at this time.

Enrollment Without Java Cards

When Java cards are not being used, the membership key must be generated on a PC. In this case, following the order of enrolling all the members at the next level would result in security exposures that may be too great for many organizations. These include the following:

Because the membership key s would be generated on the administrator's PC rather than on the member's card, the administrator would be able to access both the public and private membership key s.

The private membership key is vulnerable during whatever time and distance is needed to transport it to its final destination.

Without protections such as those implemented in the hardware of the Java card, storage of the private membership key on hard disk drive or floppy disk leaves it exposed to those with motivation and talent.

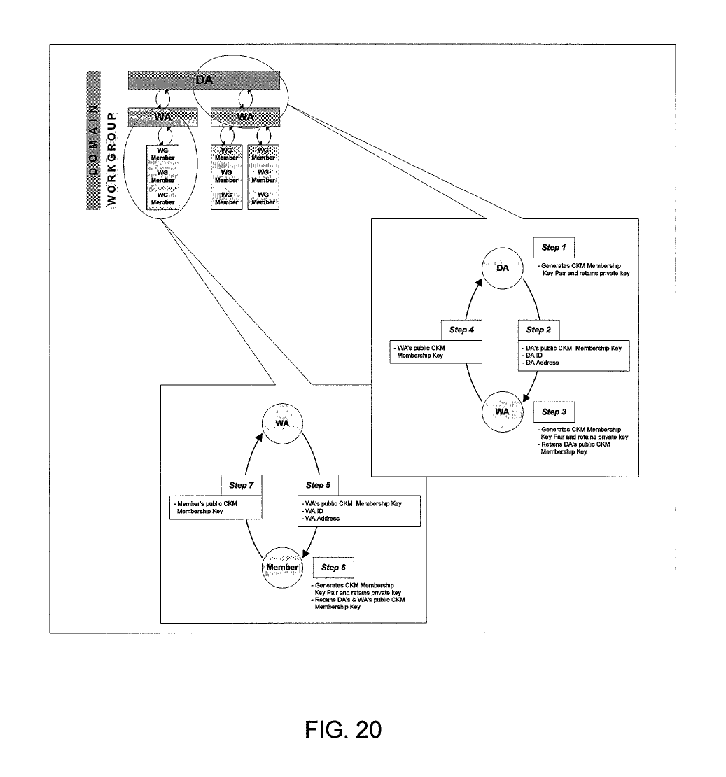

Although the third problem cannot be resolved fully in a PC environment, modifications to the enrollment process can eliminate the other security exposures. In a cardless environment, enrollment should not proceed in a top-to-bottom sequence, but must flow in both directions. Assignment of WAs to a DA and of members to a WA and DA continues from top down. However, all Domain members, including DAs and WAs, generate their own membership keys and, in general, distribute the public half in a bottom-up direction. The steps in this type of enrollment process are illustrated in FIG. 20 and listed below:

1. The domain authority generates her membership keys. The private membership key is maintained locally in her member profile, while the public membership key is distributed to each workgroup administrator, along with the ID and address of the DA.

2. Each workgroup administrator stores the provided public membership key to approved local media. The WA then generates his own membership keys, retaining the private membership key and returning the public membership key to the DA at the address provided.

3. Each workgroup administrator sends his own and the DA's public membership key to workgroup members, along with the ID and address of the WA.

4. Upon receipt of the items in Step 3 from the WA, members store the DA's and WA's public membership keys to approved local media. Members then generate their own membership keys, retaining the private membership key and returning the public membership key to the WA at the address provided.

5. If identification and/or personalization data is to be maintained by the workgroup administrator, copies of these should also be returned to the WA.

Once these steps are completed, profiles may be distributed as described below.

Profile Distribution

Credentials, algorithm permissions, policy settings and other resources needed by the system of the invention are maintained in profiles. Beginning with the raw information created by the domain authority, profiles are created and distributed through the administrative hierarchy. This section discusses responsibilities and methods for distributing profiles effectively and securely.

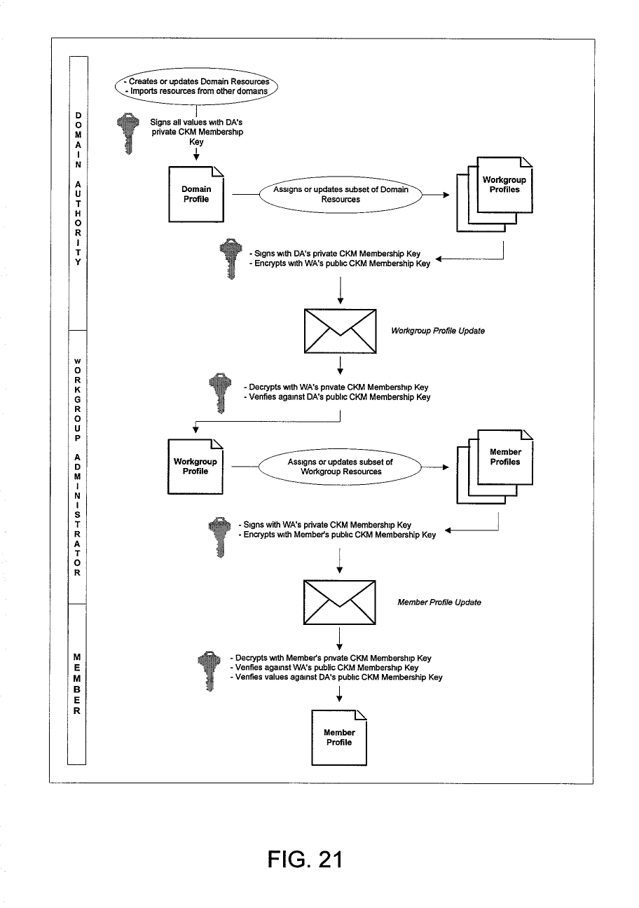

Although organizations may design a distribution system to meet their unique needs, a standard distribution system according to the invention is illustrated in FIG. 21, as an example.

Domain Authority Responsibilities and Procedures

The domain authority is responsible for creating the resources used in the domain, assigning these resources to workgroups, and updating them at times. Additionally, if required, the domain authority establishes trust relationships with other domains by exporting a subset of credentials to other domains, or importing credentials provided by other domains.

Creating the Domain Profile

To establish the domain, the domain authority performs the following tasks:

Names the domain—at which time a domain value is generated—and provides information further identifying the domain.

Generates and names the credentials that will be used in her domain. An asymmetric key pair is created for each credential—the primary key, known as the read value, is used for decryption, while the derived key, known as the write value, is used for encryption. Each of these credential values is digitally signed using a domain signature, and stored in the domain profile.

Selects and names the cryptographic algorithms that will be available in the domain. An algorithm permission string is signed and stored in the domain profile.

Establishes policy settings that set the outer parameters affecting how the invention is used within the domain. Each policy setting is signed and stored in the domain profile.

Selects Identification and Authentication objects, and groups them into I & A configurations to be used throughout the domain to authenticate members.

Generates a Maintenance Sequence and sets the current maintenance level. The maintenance sequence is a series of values calculated in a manner such that, given one value in the series, any prior value may be derived. The starting value is signed and stored in the domain profile, while the final value is set as the first maintenance level. Since prior values may be generated at any future time, the rest of the sequence may be discarded.

Creating and Distributing Workgroup Profiles

After establishing the resources needed in the domain, the domain authority creates workgroup profiles and distributes each to a workgroup administrator. The DA performs the following tasks for each workgroup:

1. If not already enrolled, enrolls the workgroup administrator, as described in the enrollment process section, above.

2. Creates a workgroup profile for the workgroup. The DA selects a subset of credentials and algorithm permissions to be available in the workgroup, and refines policy settings for the workgroup. For each credential selected, she may provide only the read value, the write value, or both read and write values to the workgroup. Each of these pre-signed values is inserted into a workgroup profile update as an Add transaction. The current maintenance value and level, along with the domain value and I & A configurations, are also entered into the workgroup profile.

3. Encrypts and signs the workgroup profile update. The DA encrypts the workgroup profile update with the WA's public membership key, signs it to insure that no changes are made during distribution to the workgroup administrator.

4. Distributes the update to the workgroup administrator via e-mail, diskette, or other means suitable to the organization.

Maintenance Activities

The domain authority maintains the domain profile by adding, deleting or revising domain credentials as needed. She also updates the current maintenance value in use by generating the next available value from the maintenance sequence and increases the maintenance level.

In the standard administration applications according to the invention, a representation of each workgroup profile is saved by the domain authority. Workgroup Profiles may then be reviewed and updated to reflect changes in the domain, or to add or delete credentials available to the workgroup. Workgroup profiles are also updated whenever a new maintenance level is assigned. Changes made to the DA's copy of a workgroup profile are then packaged as transactions into a workgroup profile update and distributed to the workgroup administrator following the steps described above.

Trusted Domain Relationships

The domain authority establishes a trusted relationship with another domain by exporting a subset of credentials and algorithm permissions. For each selected credential, the DA elects to provide the read value, the write value or both the read and write values to the trusted domain. These pre-signed values are packaged into an export update, along with the domain name and value and the current maintenance value and level. To distribute the update to the trusted domain, the following steps are taken:

1. The DA of the originating domain provides her public membership key to the DA of the trusted domain. If maximum security is desired, the DA's membership key should be signed using a global key registered with a PKI in which both DAs participate.

2. The DA of the originating domain signs and encrypts the export update to insure that no changes are made to it during distribution.

3. The DA of the originating domain delivers the update via e-mail, diskette, or other medium suitable to the organizations.

The domain authority accepts a trusted relationship by importing an export update provided by the DA of another domain. When importing, the following steps are taken:

1. The update provided is decrypted and verified against the signature provided by the originating DA.

2. Each value is unpacked and verified against the signature of the originating DA.

3. The domain name and value along with the maintenance level and value are added to or updated in a trusted domains section of the domain profile.

4. Remaining values are added to or updated in the domain profile.

The domain authority may then update workgroup profiles within her domain to distribute credentials from the trusted domain.

In no case are policy settings from a trusted domain accepted or distributed. The system of the invention always enforces the policy settings of the domain to which members belong, even when using credentials provided by another domain. By the nature of the trust relationship, the domain providing credentials trusts the second domain's distribution practices and use of policies to protect its credentials.

Workgroup Administrator Responsibilities and Procedures

Each workgroup administrator receives updates to the workgroup profile from the domain authority, hones policy settings to the needs of his workgroup as allowed by the DA, and creates, updates, and distributes member profiles to the members of the workgroup.

Accepting Workgroup Profile Updates

A workgroup administrator accepts a workgroup profile update by performing the following activities:

1. Verifies the authenticity of the profile update package against the DA's public membership key received during the WA's enrollment.

2. Decrypts the profile update package using his private membership key.

3. Unpacks each transaction instruction

4. Verifies the DA's signature for each value or transaction, and performs the transaction.

Creating and Distributing Member Profiles

The workgroup administrator is responsible for refining policy to better meet the needs of his workgroup, and for assigning credentials and algorithm permissions to the workgroup members. The WA performs the following tasks for each member of the workgroup:

1. If not already enrolled, enrolls the individuals, as described in the section The Enrollment Process, above.

2. Creates a member profile for the member. The WA selects a subset of the credentials and algorithm permissions available in the workgroup, and assigns them to the member profile. For each credential selected, he may provide only the read value, the write value, or both read and write values, if available. Each of these DA-signed values is inserted into a member profile update as an add transaction. The current maintenance value and level, all enforced policy settings, and the domain value are also entered into the member profile update.

3. Encrypts and signs the member profile update. The WA encrypts the member profile update with the member's public membership key. He signs the final package to insure that no changes are made to it during distribution to the member.

4. Distributes the update to the member via email, diskette, or other medium suitable to the organization.

Maintenance Activities

The workgroup administrator maintains each member profile by adding, deleting, or revising credentials as needed.

In the standard administration applications according to the invention, a representation of each member profile is saved by the workgroup administrator. Member profiles may then be reviewed and updated to reflect changes in the workgroup, to add, delete, or revise credentials available to the member, or to renew credentials near expiration. Member profiles are also updated whenever a new maintenance level is received from the domain authority.

Changes made to the WA's copy of a member profile are packaged as transactions into a member profile update and distributed to the workgroup member following the steps described above.

Reassigning Members

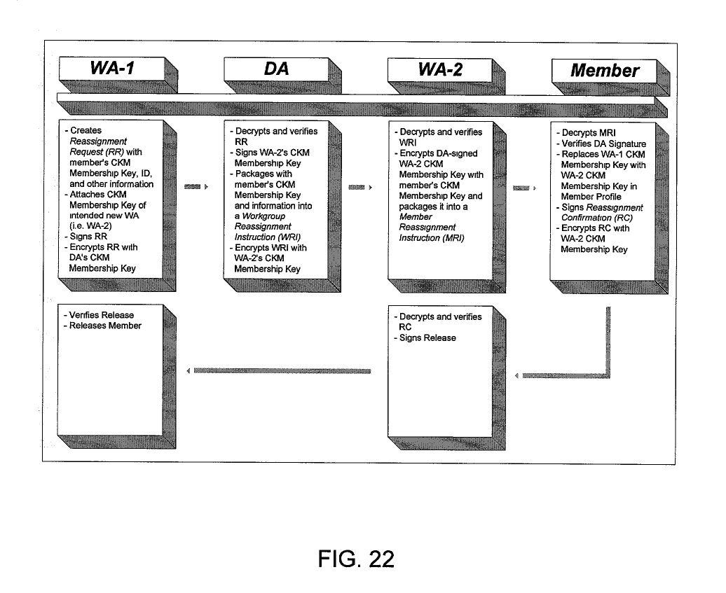

From time to time, members will need to be reassigned to a different domain or workgroup. Because all resources in a member profile are owned by the domain, reassigning a member to a new domain requires enrolling the member anew, as described above in the section The Enrollment Process. Reassignment to a new workgroup, on the other hand, may be accomplished by following the procedures depicted in FIG. 22 and described below.

As discussed earlier, workgroup members are bound to a workgroup administrator via the WA's public membership key installed in the member profile. This key is used to verify not only the authenticity of profile updates, but also the authority of the WA who signed them. If the signature verifies against the WA's public membership key installed in the member profile, the update is deemed both authentic and authorized.

This method of insuring authority is, however, valid only if the installed WA's public membership key cannot be changed without a prevailing authority. Therefore, the system of the invention requires that any instruction to change the installed WA key will be carried out only if signed by the domain authority and verified against the DA's public membership key installed on the card. Because, short of re-enrollment, the DA's key cannot be changed, the chain of authority is upheld.

To reassign a member to a new workgroup, the current workgroup administrator performs the following steps:

1. Obtains the public membership key of the intended new workgroup administrator.

2. Deletes all credentials and algorithm permissions from the WA's copy of the member profile, and distributes a member profile update to the member to remove them from his copy.

3. Packages both the member's and the intended new WA's public membership keys and addresses in a reassignment request.

4. Signs the reassignment request and encrypts it with the DA's public membership key.

5. Sends the reassignment request to the domain authority.

The domain authority decrypts the reassignment request and verifies the originating WA's signature. The DA may then review each request for approval, or may use an automated procedure to continue the process without further review. Unless the request is rejected, the DA performs the following steps to continue the process:

1. Signs the new WA's public membership key.

2. Packages the WA's signed key with the WA's address, the member's public membership key, and the member's address.

3. Signs this workgroup reassignment instruction and encrypts it with the new WA's public membership key.

4. Sends the workgroup reassignment instruction to the new WA at the address provided.

Upon receipt, the new WA decrypts and verifies the workgroup reassignment Instruction. He then performs the following steps to continue the process:

1. Inserts his DA-signed public membership key and address into a member reassignment instruction.

2. Encrypts the member reassignment instruction with the member's public membership key. Since the member does not yet hold the new WA's key, the member reassignment Instruction cannot be signed. Since the WA's key contained within the member reassignment instruction retains the DA's signature, it may be sent unsigned without risking security.

3. Sends the member reassignment instruction to the member at the address provided.

When received by the member, the system of the invention decrypts the member reassignment instruction and verifies the DA's signature. If authentic, the former WA's public membership key is replaced with that of the new WA in the member profile. A reassignment confirmation is then signed and sent to the new WA at the address provided.

Once the reassignment confirmation is received, the new WA creates a new member profile and distributes a profile update to the member. The new WA digitally signs a release and sends it to the former WA to complete the process.

Member Identification and Authentication Management

The system of the invention provides a very flexible and dynamic system of member identification and authentication (I&A). It supports multiple identification objects, which may be grouped into different configurations for different domains. Within domains, furthermore, the invention provides the ability to scale I&A configurations to the specific requirements of specific workgroups and applications.

This section discusses the methods and procedures provided by the invention to manage identification and authentication services.

Registering Available Identification Objects

The crypto service provider (CSP) provides most identification and authentication services in the system of the invention. The methods and properties is of each specific type of I&A are programmed into an independent identification object—that is, each identification object contains within itself all the methods and attributes necessary to use it with the invention. In this manner, new objects may be added to the invention and existing objects may be upgraded via minor updates of the CSP. The system of the invention supports objects such as user IDs and passwords, as well as fingerprints and other biometric objects.

To insure that all I&A objects supported in the CSP are available in the domain, the system of the invention requires that the CSP is registered with the domain authority. During registration, a DA process reads the attributes of each included identification object. These attributes include the name of the I&A object, the general class of the I&A object (for example, fingerprint or keyboard entry), required devices (for example, fingerprint scanner), and object-specific attributes that require DA setting or decision.

Additionally, most identification objects support policy that is unique to the specific object. For example, policies regarding the text length and format might be used by a password object but make no sense for a fingerprint object. Therefore, in addition to general policies provided by the CSP, each identification object includes its own set of policies that are registered with the domain authority.

During the registration process, the attributes and policies of each available identification object are read by an ASP process, and stored in the domain profile.

I&A Configuration

Once the CSP has been registered and its identification objects read, the domain authority determines which objects are supported in the domain, and combines them into allowable I&A configurations.

Determining if an I&A object is to be supported within a domain typically requires only the knowledge of whether the object's required devices are available. Although a release of the CSP may include a fingerprint object, for example, the domain will not be able to use it if it has no fingerprint readers. In this case, despite the invention's support of the object, the domain authority may elect to not make it available in the domain.

Once availability has been determined, the domain authority groups the supported identification objects into I&A configurations that may be used in the domain. Each configuration contains either one identification object, or a combination of identification objects. For example, a domain might support the following I&A configurations: UID+password, fingerprint, and fingerprint+password

Given the set of configurations listed above, the following I&A methods would be allowed in the domain:

1. The member must enter his UID and password. This method requires that the member provide something he shares with the system (UID) and something he knows (password). Furthermore, since authentication is tested against encrypted data in the member profile, the member must also provide something he holds (namely, the member profile).

2. The member's fingerprint is read and the member provides his member profile, which contains a fingerprint template recorded during enrollment or personalization. This method requires that the member provide something he is and something he holds.

3. The member must provide his password and his fingerprint, as well as his member profile. This method requires that the member provide something he knows, something he is, and something he holds.

Note that although the invention in general permits DA's to require only a password, the set of I&A configurations established by this exemplary DA does not allow this method. Similarly, since there is no configuration in this example that combines fingerprint, UID, and password, this domain allows no I&A method that would require all four classes of identification objects—something the member holds, knows, shares and is. This example, is not meant to be a limitation on the invention, however, and the system of the invention can be used to allow a method that requires any combination of the four classes of identification objects.

Distributing I&A Configurations

Once established, I&A configurations are automatically included in workgroup and member profiles and distributed with profile updates. The configurations are included in profiles as a small-format map. The size of these maps varies with the number of configurations and the number of I&A objects included in each. Each configuration requires 1 byte, plus 1 byte for each object in the configuration. The set of three configurations in the example discussed above would produce an 8-byte map. Since the I&A classes in the CSP contain all attributes and methods of each I&A object, no other information needs to be distributed.

By policy, the domain authority may allow specified workgroup administrators to tailor the set of I&A configurations to the needs of the workgroup. If allowed, the WA is able to exclude any of the configurations for use by the members of the workgroup. For example, a workgroup of clerical staff might be excluded from using a configuration requiring fingerprint plus password plus UID. As will be shown in the next section, if this configuration is linked to high security applications, the clerical staff would be unable to access these applications.

Although typically used to exclude I&A methods that provide less secure authentication, allowing WA's to tailor the I&A map allows them to exclude any I&A configuration. If permitted, that is, a WA may exclude an I&A configuration that might be considered more stringent than others. Therefore, this permission should be granted with care.

Scaling I&A to Applications

In addition to the flexibility inherent in the CSP's support of multiple, configurable I&A services, the invention also provides the ability to scale I&A requirements to applications. That is, domain authorities may balance convenience versus speed versus security for specific applications.

The process of linking I&A configurations to an application is accomplished in two steps: reading and signing the application.

Reading Applications

As part of its attributes, the application may request certain I&A objects or classes (types of objects). These requests are suggestions by the application developers as to which I&A objects are appropriate, based on the functionality of the application. While most third-party commercial applications will make only very general requests, custom-developed applications may request very specific objects.

A process provided by the ASP reads these requests and presents them to the domain authority.

Signing Applications

Regardless of its I&A requests, the domain authority may assign specific I&A configurations to applications. This assignment is enforced by the DA's signing the application, as discussed in the section below.

Linking I&A to an application requires only that the DA select which I&A configurations may be used to gain access to the application. If more than one configuration is assigned, the application will run if the member is authenticated by any of the configurations. An application, however, will pass the invention's application authentication tests and be able to run only if all of the following conditions are met:

1. At least one of the configurations assigned to the application is allowed in the I&A configuration map held by the member as part of his profile; and

2. All devices required by a configuration that is both assigned to the application and the member are available; and

3. The member passes the I&A process.

If no configurations are assigned to an application, the application will run if the member is authenticated by any I&A configuration allowed in the I&A configuration map held by the member as part of his profile.

Linking I&A configurations to applications in this manner provides greater control over which members may use which applications at which locations.

Managing Policy

The system of the invention enforces policy at two levels: CSP policy and application-specific policy. The management and enforcement of each of these levels is discussed below.

CSP Policy

The invention's crypto service provider (CSP) includes several policies that are enforced for all applications. Some of these policies are generic and are enforced regardless of configuration, while others are class-specific and are enforced only in certain configurations.

Generic Policy

Generic policy includes issues such as duration of credential validity, session time-out, member profile storage medium, and others. These policies are distributed to and included in all member profiles and are enforced every time the invention is run. Settings for generic policy are initially set by the domain authority, who may, on a policy-by-policy basis, allow workgroup administrators to further restrict the settings.

Class-Specific Policy

Some object classes in the CSP require the enforcement of additional policies that are specific to the functions of the class. As already discussed, for example, I&A services require policies that are unique to each type of I&A object. Similarly, policies regarding the use of smart cards apply only if smart cards are actually used.

Class-specific policies are enforced only if the domain or workgroup configuration employs these classes. If the domain configuration established by the DA does not require the use of a class, none of its specific policies are included in the domain profile and are thus not available for the DA to set. In this case, these policies will also not be included in workgroup profiles or distributed in workgroup profile updates. Similarly, if the configuration is tailored by a workgroup administrator (when allowed by the DA), some classes may no longer be needed. In this case, specific policies related to these classes will not be included in member profiles or distributed in member profile updates.

Settings for class-specific policy that is enforced are initially set by the domain authority. On a policy-by-policy basis, the domain authority may allow workgroup administrators to further restrict settings.

Application-Specific Policy

Some applications may require policies in addition to those provided in the CSP. A file system driver, for example, might require a policy determining whether files must be encrypted or if they may be saved unencrypted. Whereas most commercial applications handle similar issues as user-selected options, applications according to the invention enforce these “options” as policy set by the domain authority and, where applicable, workgroup administrator rather than the member.

Registering Application-Specific Policy

To enforce application-specific policy, the application must be registered by the domain authority. Registration is provided by an ASP method that reads the attributes of classes in the application. If any application class includes policy attributes, the policy is added to the domain profile and presented to the domain authority to modify its settings. Application-specific policy will be enforced only if the application is registered and signed by the domain authority. If not registered, the application may not run properly, if at all.

Once registered, the domain authority may elect to include an application's policy in workgroup profiles and workgroup profile updates. If not included, the application's policy will not be included in member profiles or distributed in member profile updates.

Policy Attributes

All policy attributes are provided by the class owning the policy. The values of most attributes, such as policy name and description, are maintained within the class—not in domain, workgroup, or member profiles. The values of attributes that may be set by domain authorities and workgroup administrators, however, are maintained only in profiles, while attributes used to identify the policy are stored both in the class and profiles. Given the values of these identity attributes, the CSP provides methods for a class to retrieve the values of policy settings from the profile. Likewise, the ASP includes methods to retrieve the identity attributes of all classes. Given a set of attributes, methods included in the ASP can retrieve the values of fixed attributes from CSP or application classes, as well as the values of attributes that may be set from a profile.

Methods of Enforcing Policy

All methods used to enforce policy are provided by the CSP or application class providing the policy. Generic and class-specific policies provided by the CSP are enforced by and within the CSP. Application-specific policies, however, are enforced by classes in the application. The CSP merely acts as an intermediary between a member profile and the classes of the application—providing the values of attributes that may be set to classes for enforcement by its own methods.

This design allows the system of the invention to acquire policy intended to meet the requirements of unique applications without having to, itself, know what the policies are or how they are enforced. Many new applications may be developed that would otherwise not be able to take full advantage of the invention. However, since the nature of an application-specific policy and its methods of enforcement are known only by the application, the invention can neither control nor monitor the manner, quality, and security of enforcement of application-specific policies. It is, therefore, recommended that domain authorities submit applications that include their own policy to careful review prior to registering and distributing them.

Authenticating Applications

The system of the invention provides the ability to insure the authenticity and authority of applications used in a domain. This process may be used for any or all applications installed in the domain to prevent the use of applications that have not been authorized by the domain authority, and/or which may have changed since being reviewed by the domain authority. The process of authenticating applications is also required to enforce application-specific identification and authentication, as well as to enable application-specific policy.

Registering and Signing Applications

Application authentication services are available only if the application is registered and signed by the domain authority. The registration process checks for any application-specific policy or requested I&A objects. If found, these policies and I&A requests are read and added to the domain profile for processing and distribution, as described previously.

Following registration, an ASP process hashes the application's executable and writes the hash result to a small application authentication file. Additionally, any I&A configurations assigned to the application by the domain authority are added to the file in a protected manner. The application authentication file is then digitally signed by the domain authority and written to diskette or a network directory for use when installing the application to individual locations.

Application authentication does, of course, add some overhead. If desired, domain authorities may set a generic policy so that authentication of applications is not required. In this case, services will be provided if no application authentication file is included with the application. If this file is included, services will be provided only if the application is verified.

Verifying Applications

Prior to running the services, the CSP attempts to locate an application authentication file associated with the calling application. If found, the application's authorization and authenticity is checked in the following manner:

1. The application authentication file is authenticated against the DA's public membership key found in the member profile. If the signature is not verified, the file is considered either to be unauthorized or to have changed since it was authorized. In either case, an error is returned and the application is not provided with services.

2. The application's executable is hashed and the result is compared to the hash contained in the application authentication file. If these values do not match, the application is considered to be unauthorized or its executable is believed to have changed since being authorized. In either case, an error is returned and the application is not provided services.

3. If I&A configuration assignments are contained in the application authentication file, they are decoded. The results are then used by the invention's I&A services to authenticate the member, as described above. If the member does not pass I&A, an error code is returned and the application is not provided with services.

If an application authentication file is not found, provision of services to the application is determined by policy. If this policy requires application authentication, an error code is returned and the application is not provided services. Otherwise, provision of services is left up to the invention's identification and authentication process.

Exemplary Embodiment

The Scenario: Gnieob-Cescet, Bucovolia: A confrontation between ethic minorities in the Bucovolia town of Gnieob-Cescet turned violent when a bomb exploded, injuring several hundred people. To protect strategic interests, the U.S., France, Great Britain, Germany, and other Western European nations have entered a coalition, to Cucovolia, Bucovolia's neighbor has recently left the coalition, spawning speculation that they may be collaborating with ethnic minorities in Bucovolia.

The coalition relies on a massive and complex information processing, communications, and decision support infrastructure. The international coalition relies on ACKMENTI for rapid creation of a secure communications and computing infrastructure supporting the coalition.

Currently, the U.S., Great Britain, and Germany share a common key management and distribution infrastructure. France has its own key management and distribution infrastructure. This infrastructure rests in part on France's secret encryption technology.

Setting the Stage: The policy of the United States must be reflected in a dynamic coalition program where enforcement of dynamic policy changes can be enforced through the use of encryption and key management.

Governments need to be viewed as autonomous entities that, through a common interest, are willing to establish a trust relationship or a coalition. A coalition relationship can be addressed from various views that will then determine the resultant cryptographic key management strategy.

1) From a U.S. perspective, a coalition force has historically been dependent on a pre-defined U.S. encryption equipment and key management model for which all keys are obtained from a single U.S. source, such as the National Security Agency. A coalition partner is added or deleted by a physical distribution of equipment and keying material. In this way, key management meets current U.S. release authority policy. The coalition partner has no key management autonomy. In the scenario above, the U.S. would distribute encryption equipment and keying material to all the members of the coalition.

2) From a coalition partner perspective, such as France in the above scenario, they want to be able to securely communicate among all the partners, but France wants to introduce its own secret generation and distribution key management capability. Like France, the U.S. will share information with its coalition partners, but the U.S. wants to restrict those partners from U.S. only information. It can be assumed that other partners will want to establish a secret ring of information.

Essential is a dynamic key management architecture that can offer anonymity for each partner that may be employing different variations on PKI implementations.

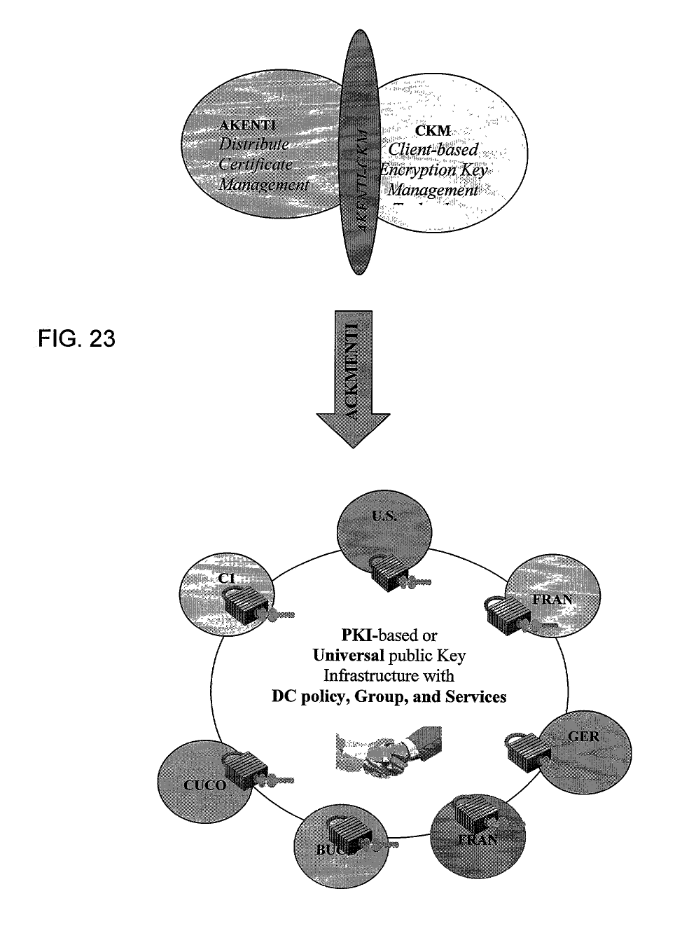

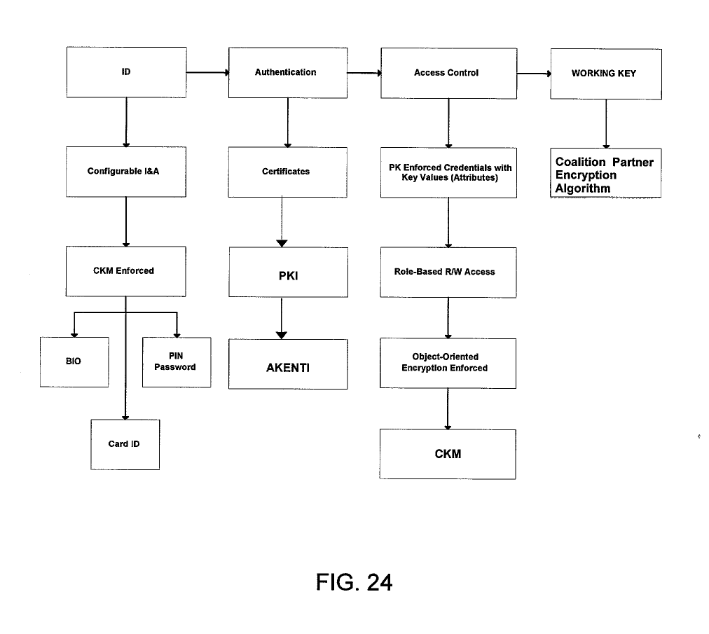

As shown in FIG. 23, AKENTI-CKM integration offers the certificate and key management capability between coalition members and the PKI-based world. ACKMENTI is a byproduct of AKENTI-CKM integration, here depicting the dynamics of coalitions reflected in the proposed scenario. FIG. 24 illustrates application of the scenario of FIG. 23 to the key management overview of FIG. 1.

Within a coalition partner relationship, trust can be viewed as a tiered approach for which a partner may establish within its own domain or encryption boundary a set of the partner member's relationship to information.

1) Trust can be viewed through a balanced key management architecture such as ACKMENTI.

2) A partner must ensure that the identity of its members is validated—a form of first person trust that is established between the members and its “authorization and access rights”.

3) A partner may use a third party trust architecture represented by a PKI. PKI would provide authentication of the member to the coalition. A partner issues the certificates.

4) Further within the PKI model would be an authorization capability that applies the certificates to “use-conditions” that reflect policy guidance.

5) A set of attributes that correlate to credentials is established for each member that defines access control limitations to information and reflects the coalition policy for a partner.

6) The aggregate key management architecture results in a session working key that can be used with a coalition partner encryption algorithm.

A Mix of Key Management Technologies: ACKMENTI is an integration of two core key management capabilities as defined in AKENTI and Constructive Key Management (CKM, the invention). AKENTI is a system for distributed management of distributed authorization based on certificate, attribute, and use-condition verification. CKM is a key management system that a partner can use to manage the flow of and access to information at an object or channel level. The integration of these technologies would result in a strong distributed coalition capability:

1) Maintenance of policies representing multiple domains or encryption boundaries and expressed in multiple policy languages.

2) Representing multiple policies, and representing the partner as a policy authority and attribute-certifier trust authority in human readable form. These attributes are correlated to a credential for access control enforced by encryption.

3) Providing for hierarchical structuring of compound policy statements that can be reflected in a supporting key management generation and distribution architecture.

4) Providing for integrity of the overall policy.

5) Providing for integrity of individual policy statements made and maintained by distributed partners.

6) Providing for assured semantic interpretation of policy by binding policy statements made in different policy languages to appropriate interpretation engines and further binding the policy statements to the key management linkage.

7) Context sensitive authorization and rapid response to, say, a Byzantine attack will be provided through dynamic member attributes and credentials that can be rapidly changed according to the context via appropriate interaction between the authorization and access control systems.

8) The use of agents to accomplish DARPA missions can involve mobile agents operating in embedded devices, or similarly resource-poor environments. AKENTI has already been integrated into an agent system providing secure mobility and authorization (ANCHOR). However, in a small system scenario where there are not sufficient resources to do policy analysis, an external authorization function will be needed. To address this, AKENTI will be enhanced with the functionality needed to support its use as a standalone service.

9) Auditing is needed for intrusion and Byzantine attack detection. AKENTI will provide detailed, real time information on the resource being accessed, the identity requesting the resource, steps in the acquisition and interpretation of policy, time taken to grant/deny access, etc. CKM can provide audit data to AKENTI, if additional information is required.

10) Authorization for access control: AKENTI will serve as a front-end to the CKM access control system in order to provide authorization supporting the access control process. Mechanisms incorporate various member profiles (e.g., operating restriction profiles) into the authorization management process in ways that allow these profiles to be passed to the access control system for enforcement.

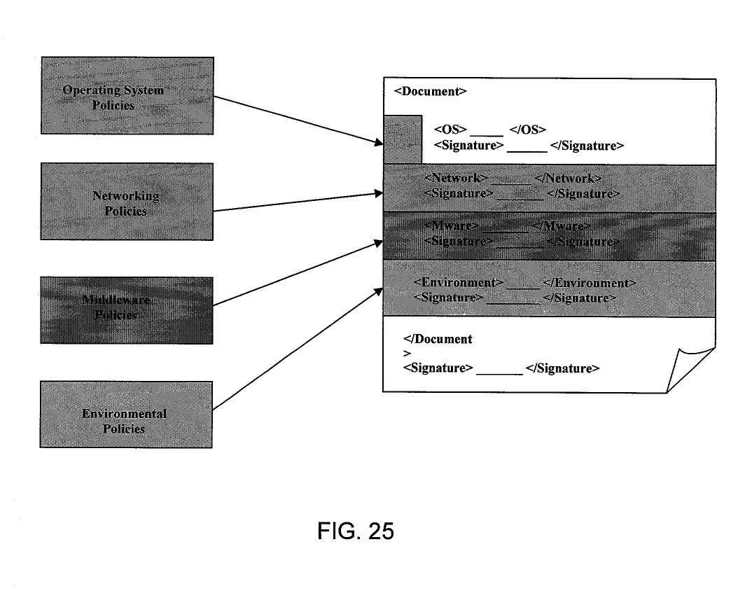

Multi-dimensional Policy Management: Dynamic coalitions require multidimensional policy and immediate reactions to rapidly changing policies. Additional capabilities include incremental updates to the policy while maintaining the integrity of the security policy. Policies represent multiple domains and are expressed in a human-readable format, which are the interpreted by appropriate policy analyzers in order to translate them into computer readable format for enforcement and execution. An exemplary multi-dimensional policy representation is illustrated in FIG. 25.

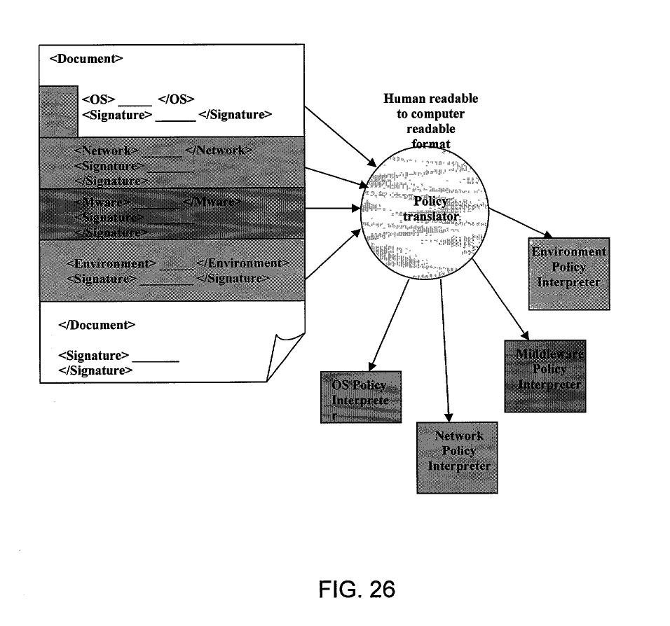

With reference to FIG. 26, the XML standard for policy specification is proposed considering the following merits:

a) Dynamic adaptation: Computing digests on a per node basis is possible in XML because of its DOM tree representation. As a result, it is possible to dynamically update portions of the document without affecting the other parts of the document. The signature of the entire document and that of the node maintains the integrity of the document.

b) Human readable: Humans easily interpret XML format. This can be inferred from its wide acceptance for web-based applications.

c) Incorporate BLOBS: XML can accommodate BLOBS encoded in base 64 format that may be required by certain domain-based applications.

d) Further advantage of adapting XML standard for policy representation in DC:

1. Maintenance of policies representing multiple domains and expressed in multiple policy languages.

2. Representing multiple policies and representing the partner as a policy authority and attribute-certifier trust authority in human readable form.

3. Providing for hierarchical structuring of compound policy statements.

4. Providing for integrity of the overall policy.

5. Providing for integrity of individual policy statements made and maintained by distributed partners.

6. Providing for assured semantic interpretation of policy by binding policy made in different policy languages to appropriate interpretation engines.

Access Control Enforced through Encryption: Access control of the invention can compliment certificate attributes. CKM is a process by which an organization can manage the flow of and access to information at the object level. The invention provides a cryptographic key management technique that embeds access attributes, time, location, and other selected parameters within the object. The CKM architecture is intended to work within a balanced key management environment, as illustrated in FIGS. 1 and 24, that incorporate the strengths of asymmetric and symmetric encryption elements. Included in the architecture is an encryption key generation process based on key values and asymmetric credentials, a random value process, and an infrastructure to support the distribution and management of the generated elements.

CKM is an evolving key management architecture that can be represented as a symmetric-only design, or with additional asymmetric elements can be expanded into a more advanced trust model. The later trust model is advantageous for use with a suite of financial community standards—the ANSI banking standards. Inherent in the design is an encryption property called key recovery that allows the owner of the technology 100% recovery of each encrypted object.

The key management architecture of the invention may be viewed in several parts that constitute an entire system's identification, authentication, access control, and encryption cycle supported by a management infrastructure.

As discussed previously, the key used in the encryption of an object is called the working key. It may be used like keying material for a session key or a message encrypting key that is needed by a symmetric encryption algorithm such as the coalition partner's encryption algorithm. The working key, constructed from several pieces of information (called values), is used to initialize a symmetric key encryption algorithm, and is then discarded. The same pieces of information used in constructing the working key for encryption are used to reconstruct the working key for decryption. The function that combines the values to create a working key is central to the encrypting process of the invention.

Access control is provided in the invention by applying credentials in the encryption of information. Either symmetric or asymmetric values are associated with each credential depending on the trust design. Read/write separation is cryptographically enforced with an asymmetric key design. Read access is equivalent to decryption rights and write access is equivalent to encryption rights.

Credentials are selectively distributed to members within a domain. In general, an encryption process uses a secure channel to distribute a small amount of information (typically keys or for the invention, values, and credentials) so that a large amount of information (or a message) can be distributed securely over unsecured channels. Within the distribution architecture, a domain authority effectively grants or denies access to encrypted information. A successive level of distribution to the member, a workgroup authority, is included in the architecture. A workgroup is a mid-level organization that clusters members (or small workgroups) based on common needs and rights to information. Workgroups are administered and often established to parallel departments, locations, projects or other natural organizational subdivisions.

In addition to access control, a broader key management strategy may include a configurable identification capability and a third-party trust authentication and authorization capability as illustrated in FIGS. 1 and 24.

Credentials may be associated with an application that defines one or more member identity elements such as a biometrics function, a smart token identity, or a PIN/password. The invention is used to bind the identity elements to an encrypted object through an encryption process. The object may consist of private keying functions that can authenticate the member to the network and other members, and other functions that may need to be stored secret that are included in a member profile. Once the identity of a member has been established, the member may need to authenticate that identity through a third party trust model (PKI) and an authorization model such as AKENTI.

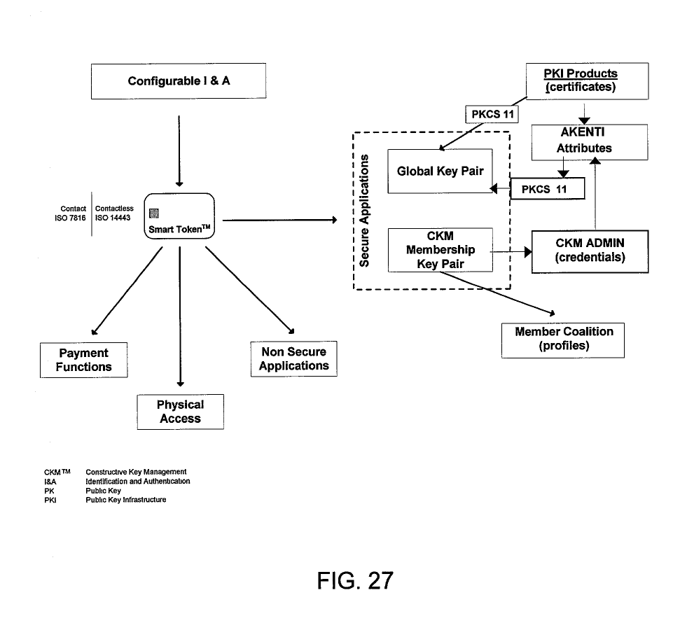

The PKI authentication and authorization support can be done through a smart token. FIG. 27 illustrates a smart token that has various inputs, such as a configurable I&A, public key support, and non-secure application support. The smart token is used as a bridge to multiple authentication and encryption platforms with varying degrees of encryption enforcement and binding.

A member profile includes the credentials, algorithm permissions, and enforced policy settings assigned to a member by a workgroup. The member profile may also include the member's private part of a public key for distribution (membership key pair) and a second private part for PKI authentication (global key pair).

The Infrastructure: Generating and distributing values and policy constitutes a major part of the administrative functions of the invention. The basic control unit of the invention is the domain. Each domain is cryptographically separated from other domains. There may be one or more domains within any organization or group of organizations, and each domain may establish a trusted relationship with other domains. A domain may be coincident with a PKI domain or may be independent, depending on system management requirements.

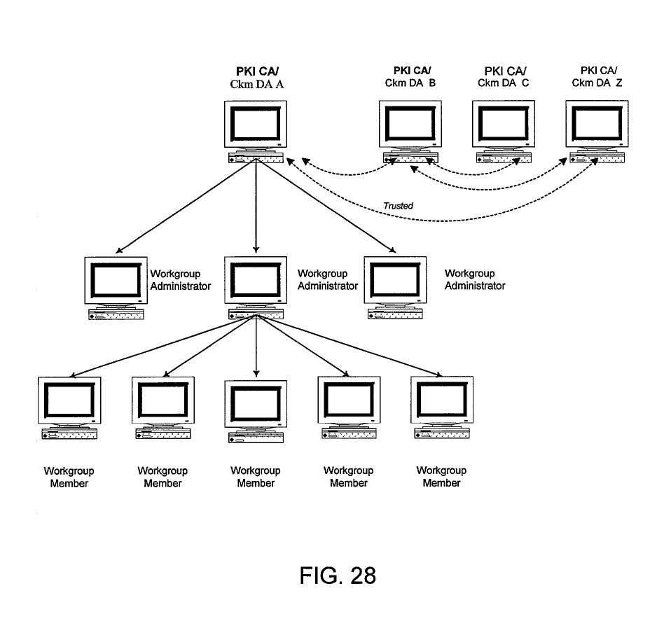

The system of the invention has a hierarchical structure, as illustrated in FIG. 28. The central point of the hierarchy is the domain authority (DA). The DA maintains control and authority over the key value process, over distribution, and over policy mandates associated with encryption and other miscellaneous security functions. A member cannot override a mandated DA action. The DA can recover object encryption keys as the owner and controller of all access rights and profiles within the system. As each encryption key is used only once, a recovered key restricts access to only one encrypted object. The DA for the invention may be supported within a CA for PKI as a certificate attribute manager.

Each member's profile is distributed as an encrypted and signed object to ensure that only that member receives what was assigned. A digital signature (membership key pair) is used as the signing mechanism. There is little burden on the network bandwidth with the distribution of profiles since they are only distributed with the establishment of a new member, the revocation of a member, or periodic updates of key values. The architecture is PC- or client-based and does not rely on server interaction for normal operations. The invention may be applied to a client-server design if the supporting information infrastructure dictates.

The combiner function and profiles: To provide confidentiality, the working key, and thus the associated values, must remain secret. Most values are distributed to members in encrypted member profiles. These profiles are protected with one or more member identity elements that may be included in a configurable identification and authentication module.

Values contained in a member's profile include the domain value, shared by all who participate in the domain, and a maintenance value, which can be updated periodically. The maintenance value may also be used to aid in enforcement of member profile revocation from a domain perspective.

The working key must be a one-time key to guard against sophisticated crypto analysis attacks and be unique enough so as not to be easily derived or guessed. A random value, generated anew for each object encryption, is used as a third value in the combiner.

The working key is used with a symmetric encryption algorithm such as a coalition partner encryption algorithm.

Since the working key is destroyed immediately after an object is encrypted, specific data to reconstruct the values and credentials and other functions are included in an encrypted header. The header-encrypting key is managed through the same scheme as the maintenance value, and both can be updated concurrently. It should be noted that it is not possible to recreate the working key solely from data provided in the header.

The role of the combiner is to create a working key from the domain, maintenance, and random values. While other values can be used by the combiner to derive the working key, as described previously, this example will focus on these three values, without limiting the general scope of the invention. The combiner process utilizes a process or relationship, such as a standardized triple DES (3×DES) algorithm, for which the maintenance value becomes the plaintext to be encrypted with DES using the random and domain values as DES keys. Of course, if other processes, relationships, or algorithms are used in place of 3×DES, the arrangement may differ from that described above. The cipher text output of the combiner function is the working key. As described previously, FIG. 4 illustrates the combiner function of this example.

Read and write access, and the protection of the random value are done through a triple DES process that derives keys from hashing the credentials and is independent of the combiner internal encryption process. If symmetric key cryptography is used for random value encryption, the keys associated with each applied credential are concatenated, in order, and then hashed. If asymmetric key cryptography is used, a Diffie-Hellman static key pair is associated with each credential and subsequent encryption process is done to derive the keying material used to encrypt the random value. The process results in other parameters that are included in the member's profile and an additional level of assurance within the combiner functionality.

The Security Paradigm and Data States: In a broad sense, security is viewed as a collection of locks, fences, guards, and equivalent virtual entries. Trust is whether the collection of entries works, and whether a member uses these entries to make life easier or to justify risks.

Encryption can be one of the security entries and a trust model. To be effective, the virtual binding from the member to the network and extended to the recipient member must include a trustworthy trail. The invention provides a base model that begins with a strong I&A that is bound to virtual protective elements that envelop an object to ensure integrity throughout the information process to the recipient. Since the invention is PC-based or client-oriented, scaling the trust model to many users is addressed by: 1) distributing the workload to end-member workstations and smart tokens, and 2) making the encrypted object the carrier of adjudication for trust and no the server. The server is a network communications manager and is not needed for the trust model. The client-oriented design of the invention can compliment the client-server design of PKI and AKENTI.

All key management architectures must have a mechanism to revoke a member's access (or on a larger scale, a partner's access). Revocation refers to preventing access to information encrypted subsequent to revocation. Once a decision is made to revoke a member, options should be available to rapidly remove the respective member. There are several techniques that can be administered to revoke a member:

1. Profile time-to-live provides a routine, periodic method of revocation. Just as credit cards expire, a profile would expire and simply not be renewed.

2. Updating the maintenance value revokes all the members within a respective encryption domain. New maintenance values have backward utility so that previously-encrypted information can decrypted, yet only those members with the new value can decrypt current information encrypted with the new maintenance value.

3. Remove a member from the certificate authority (PKI) server directory.

4. A member profile can be stored on a particular network directory in lieu of the member's PC or token. Revocation can be executed by removing a member's profile from the server.

Data may be viewed at any given time of being in certain states: The invention can provide a key management and control scheme for various data states:

1. Data at rest: data objects are in a fixed state in a storage capacity. An example of this state is an e-mail file that is managed within a store-and-forward system.

2. Data in transit: data objects that are being transmitted in a communication channel during a period of time.

3. Data in process: data objects that are in static memory areas being manipulated by a computer operating system and/or one or more applications.

In addition to an encryption process such as that provided by the invention, other security mechanisms may be considered to provide greater integrity and assurance. Each application needs to be qualified for threats and a security profile that reflects the level of acceptable risk.

Object Oriented Encryption and Role Based Access Control: Credentials (attributes) that are associated with access rights are created based on how information is used within the organization and distributed through the architecture to role groups. Under a role based access control (RBAC) system, rights and permissions are assigned to organizational roles, rather than to each user. Members, based on their assigned roles, acquire rights and permissions. As member assignments change, their rights and permissions are changed to reflect their new roles. The invention, through credentials reflecting information flow and boundaries, is well suited to an RBAC system. The architecture offers a method to anticipate data boundaries without knowing member identities. The identity process is done prior to the access control process. RBAC is inherent in the access control process.

The invention has been described using exemplary and preferred embodiments. However, the scope of the present invention is not limited to these particular disclosed embodiments. To the contrary, the present invention is contemplated to encompass various modifications and similar arrangements. The scope of the claims, therefore, should be accorded the broadest interpretation so as to include all such modifications and similar arrangements.

What is claimed is:

1. A process of checking the authorization and authenticity of an application provided by a user, comprising:
authenticating an application authentication file against a domain administrator's public membership key;
hashing an application executable;
comparing the application hash result to an authentication hash contained in the application authentication file;
denying services to the application if the application hash and the authentication hash do not match;
decoding configuration assignments in the application authentication file if the application hash and the authentication hash match;
comparing the decoded configuration assignments to the user's configuration assignments;
providing services to the application if the result of the decode is favorable; and
denying services to the application if the result of the decode is not favorable.
